(19) United States
(12) Patent Application Publication
(10) Pub. No.: US 2005/0070272 A1
(43) Pub. Date: Mar. 31, 2005

(54) Dual-radio cellular telephone and method of operation

(76) Inventor: Vassos Marangos, Lincroft, NJ (US)

Correspondence Address: VASSOS S. MARANGOS, 716 Newman Springs Rd, #294, Lincroft, NJ, 07738, US

(21) Appl. No.: 10/718,971

(22) Filed: Nov. 22, 2003

Related U.S. Application Data
(60) Provisional application No. 60/506,331, filed on Sep. 26, 2003.

(51) Int. Cl. H04M 1/00

(52) U.S. Cl. 455/426.2; 455/414.1; 455/550.1

(57) ABSTRACT

A cordless/wireless telephone system and method(s) of operation of same that provide(s) the combined benefits of corded/cordless/cellular telephony through the selective use of cellular and cordless technologies. The telephone system includes a base unit having both a cellular communications sub-system for communicating with a cellular service provider and a cordless communications sub-system for communicating with one or more cordless handsets, each of which may also include a cellular communications system and a cordless communications system which are selectably used depending on a number of factors including cordless received signal strength.

### CROSS REFERENCE TO RELATED APPLICATIONS

This application claims the benefit of U.S. Provisional Patent Application No. 60/506,331 filed Sep. 26, 2003.

### FIELD OF THE INVENTION

This invention relates generally to the field of telecommunications and in particular to dual-radio cellular telephones and methods of operation. More specifically, it pertains to a cellular telephone that integrates further radio technology in a variety of operational modes in order to emulate wired (T/R) basic telephony. This dual-radio cellular system can generate dial tone, have multiple handset extensions, operate in cellular-only or radio-only modes as well as operate in full duplex communication between the two modes.

### BACKGROUND OF THE INVENTION

As cellular (wireless) telephony has evolved through the years, its impact on society cannot be overstated. Dominant wireless standards such as Advanced Mobile Phone Service (AMPS), Code Division Multiple Access (CDMA), Global System Mobile Communications (GSM), Time Division Multiple Access (TDMA), which were originally designed with voice calls in mind, are continually being revised and upgraded to support high speed data, including 3^{rd} generation wireless standards (3G) and as such wireless communications based upon these and other emerging standards is playing an increasingly important role in everyday life.

This is due, in part, to the extensive features offered by wireless communications and because of the extensive geographic coverage provided by wireless service providers and the affordability of wireless service. Accordingly, the use of cellular phones continues to dramatically increase and many wireless users even have multiple cellular phones in addition to a wireline service.

In general terms, a cellular (wireless) network includes a number of contiguous cells each covering a small geographic area. In each cell a Base Station (BS) communicates with a numbers of mobile telephones using Radio Frequency (RF) signals. Each mobile phone is assigned a pair of frequencies, called a channel, with the transmit frequency separated from the receive frequency by a number of spectrum units (Hz) depending on the particular wireless standard employed.

With some frequency spectrum variations employed in different countries, Base Stations and mobile phones operate in the 900 MHz and 1900 MHz frequency spectrum and conform to any of a number of the known wireless standards, for example, GSM, TDMA, CDMA, AMPS or other.

Wireline (wired) communications, on the other hand uses wires instead of radio links to connect a subscriber's telephone to, for example, the Public Switched Telephone Network (PSTN). In such a wired arrangement, a subscriber's telephone typically connects to the service provider's telephone switching system through an analog link that is sometimes also referred to as twisted-pair wire link.

As a variation to this wired communications, many subscribers use cordless telephones for added convenience of mobility within or around the home. Cordless telephones include a base unit and a handset unit in which the base unit connects to the analog line telephone jack while the handset communicates with the base over a wireless link. Such cordless links typically are analog 46/49 MHz FM modulation links or digital spread spectrum in the 900 MHz, 2.4 GHz or 5.8 GHz frequency spectrum. Newer formats, such as 802.11 and BLUETOOTH, are likely cordless candidates as well. As can be readily appreciated, cordless telephones offer the convenience of mobility along with the added flexibility of multiple handsets. Cordless telephones generally exhibit varying degrees of reception depending upon the distance from the base unit and its frequency of operation. Throughout this specification and claims, we generally refer to cordless links generically, as “radio” links and the terms are used interchangeably herein.

Cellular phones are designed not to exceed an emission limit of Radio-Frequency (RF) energy set by the Federal Communications Commission (FCC) in the US, the American National Standards Institute (ANSI) and other US and International Standards bodies. While these limits are based on safety standards set by the above standards bodies and confirmed by a mandatory radiation measurement test, called Specific Absorption Rate (SAR), having a cellular antenna in close proximity makes many users of cellular telephones uncomfortable. Such discomfort is exaggerated by reports of health concerns for users of cellular telephones.

Due to the benefits of each, wireless and wireline communications tend to compliment, rather than replace one another. In particular, many users are perplexed by the different, and oftentimes difficult human factors associated with cellular telephones. Furthermore, due to the small size of mobile cellular telephones, their use is often inconvenient, especially in situations where a single glance is necessary to locate a particular button or buttons on a keypad.

Cordless telephones, on the other hand, do not suffer from such negative health concerns because while cellular telephones typically transmit at a power level between 400 mW (milli-watts) to three (3) Watts—depending on the wireless technology used—cordless telephones transmit at a relatively low power ranging from only 1 mW to 1W depending on the frequency of operation and modulation scheme thereby giving the comforting perception that the use of cordless telephones is “safer” than cellular telephones.

Due to the benefits of each, wireless and wireline communications tend to compliment, rather than replace one another. In particular, many users are perplexed by the different, and oftentimes difficult human factors associated with cellular telephones. Furthermore, due to the small size of mobile cellular telephones, their use is often inconvenient, especially in situations where a single glance is necessary to locate a particular button or buttons on a keypad.

Additionally, and unlike wired, plain old telephone system (POTS) tip/ring (T/R) analog or cordless telephony where a single telephone number/line can serve multiple telephones, cellular telephones require a different telephone number for each cellular handset. As a result, even in situations where users can afford both wired and wireless services, it is nevertheless difficult or confusing for many users to have to remember which phone and number they require/are carrying.

Accordingly, numerous attempts have been made in the art to make cellular telephones easier to use while enhancing their functionality. In particular, U.S. Pat. No. 6,351,653 B1 issued to Alberth et al., on Feb. 26, 2003 for Cellular-Telephone with Simultaneous Radio and Cellular Communications describes a wireless communications system including a cellular telephone having both cellular and radio transceivers and one or more radios, in radio communication with the cellular telephone. The communication of the cellular and radio signals permits a cellular telephone user to participate in a radio communication and likewise permits a radio communication participant to participate in a cellular telephone communication.

Additionally, U.S. Pat. No. 6,574,489 B1 issued to Uriya on Jun. 3, 2003 for Incoming Call Notification Method and Device for a Multimode Radio Device, describes a multimode radio device that transmits and receives calls via radio signals of a plurality of communication modes that provides different incoming call notification according to the communication mode used.

The attempts in the art to improve mobile telephony have not ended there, however, as Verizon Avenue, a subsidiary of Verizon Communications, has announced a prototype for a hybrid cordless/cellular phone called Verizon ONE, that uses regular telephone lines in the home and mobile networks when a caller is outside. (see, for example, http://wirelessadvisor.net/doc/12622) A chip in the phone converts from wired to cell service when subscribers move 300 feet from the home base station. From there, Verizon Wireless service picks up the signal.

Earlier, British Telecom attempted to release a phone that will serve as both a conventional cordless phone and a cell phone. The phone, named the BT OnePhone, allegedly allowed consumers to dispense with the expense and annoyance of having two phone numbers and two phones. While in a home, calls placed and received from the BT OnePhone were treated as cordless phone calls that are run through the conventional telephone network. Approximately 300 meters from the base station, the phone switched over to a GSM mobile network to become a cellular phone. Unfortunately, however, this phone dropped the call when the subscriber travels outside the range of the base station, as there was no seamless handoff.

Additional attempts to have cellular telephones operate like land-line telephones were described in U.S. Pat. No. 5,960,363 which issued to Mizikovsky et al, on Sep. 28, 1999 for “Tone Generating Apparatus For A Cellular Telephone To Simulate Tones Normally Sensed By A User Of A Land-Line Telephone”. In particular, tone generating apparatus was provided in a cellular telephone to simulate tones normally sensed by a user of a land-line telephone.

Lastly, there has been considerable interest in the concept of dual mode GSM/DECT phones. Such phones allow the user to use the wide-area GSM cellular network while out of an office or away from home, while also using the same handset at home or via the office PBX when in range of a DECT base station. (See, e.g, http://www.dectweb.com/News&Views/Features/9906Dectweb.htm)

Accordingly, a need exists for telephony improvements whereby the advantages of both wireless and wired communications are offered to a user, without many of the noted disadvantages. Such an improved wireless/cordless telephone, method(s) of operation and associated devices are the subject of the present invention.

### SUMMARY OF THE INVENTION

I have invented a cellular/cordless telephone, method(s) of operation of same and associated devices for enhanced cellular/cordless telephony such that the individual benefits of wired/wireline, cellular, and cordless telephony are available to users of my inventive telephone(s), method(s), and associated devices.

Viewed from a first aspect, my invention is directed to a “stationary-mobile” telephone which simultaneously utilizes both wireless/cellular and cordless technologies in an easy-to-use package having both a base unit and one or more handsets.

Viewed from another aspect my invention is directed to a telephone employing cellular technologies that provides a familiar, audible dial tone to a user. Advantageously, such a telephone employing my inventive concepts may be either “stationary-mobile” as above, or a wireless “unmobile”, which may remain fixed in location, but utilize cellular methods and apparatus.

From yet another aspect, my invention is directed to a cordless telephone that advantageously converts into a cellular telephone, depending upon a variety of selectable conditions such as signal strength or user preference(s).

Inventive methods are additional aspects of my invention, a first aspect being directed to a method of generating a dial tone and a method of eliminating the “send” function in a cellular telephone system.

An additional inventive method which is an aspect of the invention is a method of assigning the same cellular telephone number to two different cellular phones, as both perceived by the user of the telephone(s), and in a physical sense.

A method of reducing service costs by using wireless technologies to emulate both wired and coreless telephony is a further inventive aspect of my invention.

Advantageously, my invention minimizes exposure to RF radiation while utilizing cellular technology.

Additionally, my invention is directed to a method of remote alerting and out-of-range alarm systems to address the needs of the physically challenged or safety conscious.

Finally, my inventive methods are directed to methods of alerting the same cellular phone while calling two different telephone numbers and the selective direction of telephone calls to different cellular telephones.

Additional objects and advantages of my invention will be set forth in part in the description which follows, and, in part, will be apparent from the description or may be learned by practice of the invention.

### BRIEF DESCRIPTION OF THE DRAWING

Further objects of the invention will be more clearly understood when the following description is read in conjunction with the accompanying drawing in which:

FIG. 1 shows a Prior Art cellular network and corresponding cellular equipment;

FIG. 2 is a schematic representation of a stationary-mobile telephone according to the present invention;

FIG. 2a is a schematic representation of a simplified cellular telephone according to the present invention;

FIG. 3 is a schematic representation of an un-mobile telephone according to the present invention;

FIG. 4 is a schematic representation of a stationary-mobile telephone in communication with several type-1 and type-2 handsets according to the present invention;

FIG. 4a is a schematic representation of a dual, un-mobile telephone including a type-3 handset supporting type-1 and/or type-2 handsets according to the present invention;

FIG. 5 is a block diagram of my stationary mobile telephone or dual, un-mobile telephone according to the present invention;

FIG. 6 is a block diagram of a type-2 handset or duocell telephone having both cellular and cordless functionality according to the present invention;

FIG. 7 is a block diagram of a type-1 handset having a cordless functionality;

FIG. 8 is a flow chart depicting the method of a type-2 or type-4 handset manually or automatically switching from cellular to cordless modes and vice versa according to the present invention;

FIG. 9 is a flow chart depicting the method of operation of a type-2 or type-4 handset when approaching its base unit during an active call according to the present invention;

FIG. 10 is a flow chart depicting the method of assigning two different cellular telephones the same phone number according to the present invention;

FIG. 11 is a flow chart depicting an alternative method for assigning a single phone number to two different cellular telephones according to the present invention;

FIG. 12 is a flow chart depicting the generation of a dial tone in a cellular telephone according to the present invention;

FIG. 12a is a flow chart depicting the operation of a cellular telephone having a secondary radio system according to the present invention;

FIG. 12b is a schematic diagram of a cellular telephone having a secondary radio system activating a remote device during an incoming call;

FIG. 13 is a schematic diagram of an alternative embodiment of a telephone according to the present invention;

FIG. 14 is a schematic diagram of a base unit and multiple handsets depicting the dialing of the base unit producing ringing (alerting) in the multiple handsets according to the present invention; and

FIG. 15 is a flow chart depicting the steps associated with the scenario of FIG. 13, above, according to the present invention;

FIG. 16 is flow chart depicting the steps associated with a call redirection when a user calls the base station of FIG. 14 and is redirected to one of the multiple handsets.

### DETAILED DESCRIPTION

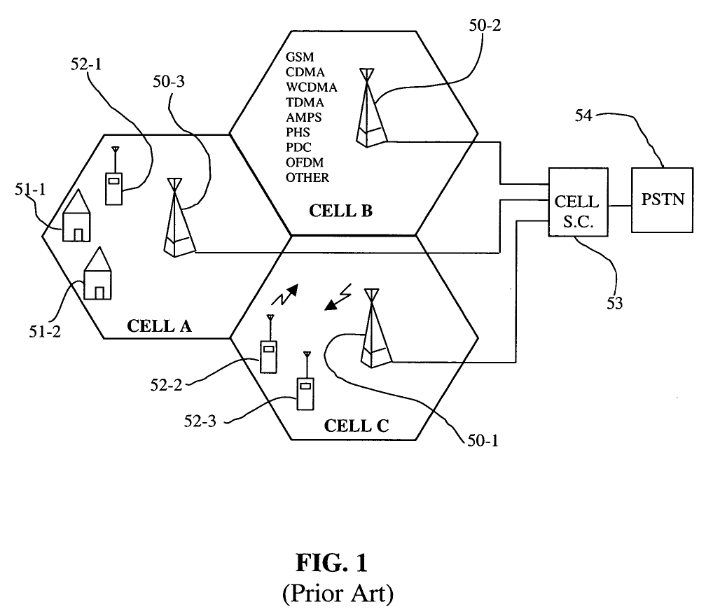

By way of further background, and with reference now to FIG. 1, there is shown a prior art generic wireless system which may employ any of the wireless standards identified prior, that is, CDMA, WCDMA (Wideband CDMA), GSM (Groupe Special Mobile), TDMA (Time Division Multiple Access), AMPS (Advanced Mobile Phone System), PDC (Personal Digital Cellular), PHS (Personal Handy-Phone System), OFDM (Orthogonal Division Multiple Access) or others which are known in the art. As shown in that FIG. 1, Base Stations 50-1, 50-2 and 50-3 are connected to Cellular Switching Center 53, which is further connected to the Public Switched Telephone Network (PSTN) 53. As used herein, and as known generally, PSTN 53 represents the landline local or long-distance carrier's switching equipment that relay telephone calls from the base stations to landline or other cellular telephones.

Each base station covers a small geographic area, a cell (shown in FIG. 1 as CELL A, CELL B, and CELL C), and communicates with mobile terminals such as cellular telephones 52-1, 52-2 and 52-3 using RF (radio frequency) signals in the 900 MHz or 1900 MHz frequency spectrum. In the cellular systems, a base station communicates with those cellular phones that are within its geographic coverage. For example, and as shown in FIG. 1., base station 50-1 services cellular phones 52-2 and 52-3. If a mobile terminal moves geographically and enters a different cell, for example, CELL C to CELL A, a handoff of the cell phone is executed between the current base station (50-1, CELL C) and the base station situated in the cell that the mobile is entering (50-3, CELL A). Although not specifically shown in the figure, cellular phones could be located within structures such as houses 51-1 or office buildings 51-2.

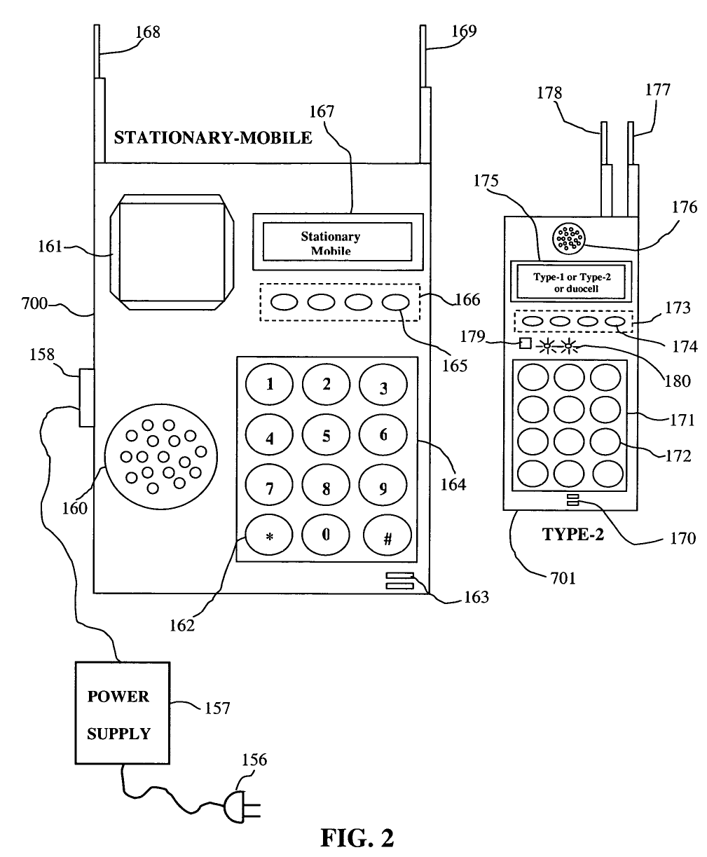

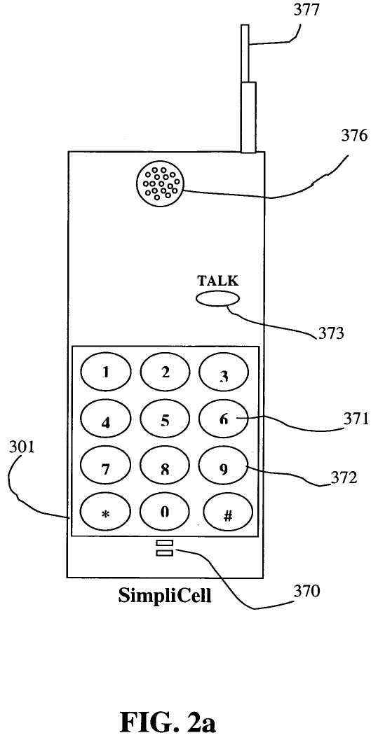

FIG. 2 shows a stationary-mobile-telephone 100 constructed according to the teachings of the present invention, which includes a base 700 and a handset 701. While not specifically shown in the figure, it should be readily understood by those skilled in the art that the base 700 may serve more than one handset 701. In particular, the number of handsets served by an individual base is limited largely by practical limitations, and not technical ones.

As used in its intended purpose, stationary-mobile telephone may serve as the primary telephone in the home or a small business. As such, this wireless telecommunications service—which is provided by a wireless service provider—may be the only telecommunications service subscribed to. Consequently, this exclusive use of wireless communications eliminates the need for wireline service thereby saving the subscriber additional expenses associated with subscribing to both wireline and wireless monthly charges.

With continued reference to FIG. 2 and as can be readily noted, stationary-mobile-phone 100 has the “look and feel” of a traditional cordless telephone except for the distinct feature of having two antenna systems 168 and 169 in its base 700 and two antenna systems 177 and 178 in its handset 701. It should be noted however, that a single antenna system in either the handset 701 or the base 700 is possible—depending on the particular frequency(ies) of operation. Additionally, while the antennas 168, 169, 177 and 178 are shown as external and visible by the user, they could be implemented to reside within the housings of the base 700 and handset 701—thereby not being visible from outward inspection

According to the teachings of the present invention, the two antenna systems operate in different modes, cellular and cordless. Additionally, and as will be described in more detail later, the handsets can be of two types, namely a type-I handset which only includes a cordless sub-system and type-2 handset which includes both cellular and cordless sub-systems.

With continued reference to FIG. 2, it is shown therein that the base of the stationary-mobile-telephone 100 includes a cradle 161 into which the handset 701 can be placed when not in use and an LCD (liquid crystal display) 167 where menus, incoming call information, outgoing call information and other visual user notification information may be displayed. Soft key panel 166 may include a number of soft keys 165 which change function depending on the manus and options displayed on the LCD and the context, or state of operation of the telephone 100. In addition, and as can be readily appreciated, optional features in base 700 (depending on the model) include keypad 164 with a number of buttons 162, for example, twelve, along with a speaker 160 and microphone 163 for hands-free speakerphone operation. Although not explicitly shown, if the speakerphone and representative 12-button keypad 164 were not included in a specific implementation, the base then would resemble a simple cradle suitable for storage, holding and charging purposes.

Unlike cellular phones, the stationary-mobile-telephone 100 provides the capability for an AC connection to the wall supply through plug 156 and an AC-DC adapter 157 which connects to the base 700 through connector 158. Not explicitly shown in FIG. 2, but readily understood by those skilled in the art, is a battery back-up system which would be necessary during power outages.

According to my inventive teachings, the handset unit 701 can operate in conjunction with its base 700 or as a stand-alone cellular telephone—when it is a type-2 handset—while away from the base 700. Conversely, a Type-1 handset, which is not wireless cellular but rather cordless, always needs to operate in conjunction with the base 700.

It is believed that when configured in a preferred embodiment, one feature that distinguishes this handset unit 700 from the traditional cellular telephone is its large buttons 172, bigger size and smaller LCD 175. The handset unit 700 shown also includes keypad 171 having twelve buttons 172, a microphone 170, an earpiece (receiver) 176, a soft key panel 173 along with a number of soft keys 180.

As noted before when discussing the base 700, Soft keys 180 are buttons that change function depending on the current setting of menu and other options displayed on the LCD and the operational context of the unit. And although in this figure four soft keys are shown, any desired number of soft keys can be implemented depending upon such factors as the size of the LCD, size of buttons and overall size of handset.

According to my inventive teachings and as shown in FIG. 2 the handset unit 701 is a type-2 handset that includes a dual antenna system having one antenna 178 that communicates in cellular mode with the nearest cellular base station and another antenna 177 that communicates in cordless mode with the base 700. An additional feature of my inventive type-2 handset is a manual switch 179 that can force the unit manually into cellular or cordless mode, as desired by a user. The dual LEDs (light emitting diodes) 180 provide the user with an indication of whether the handset is in cordless or cellular mode.

With reference now to FIG. 2a, there is shown a simplified cellular telephone, constructed according to my inventive teachings, which operates like a conventional cellular telephone and capable of supporting a variety of known cellular/wireless communications standards, i.e., GSM, CDMA, etc. As can be readily appreciated, this cellular telephone shown is extremely simple and should prove relatively inexpensive to manufacture.

Specifically, the simplified cellular telephone 300, or simplicell, includes a 12-button keypad 372, a microphone 370, an earpiece receiver 373, a talk button 373 and a cellular antenna 373. As can be seen from the FIG. 2a, the buttons 371 are generally larger than those of traditional cellular phones. The cellular antenna 373, which communicates with the nearest wireless base station (BS), can also be internal to the unit and therefore and invisible to the user.

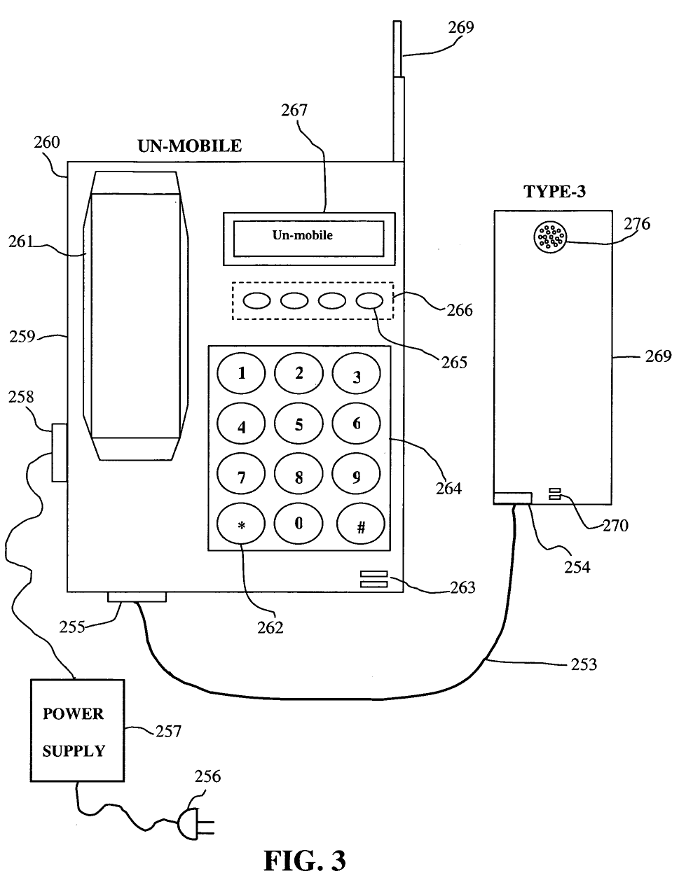

With reference now to FIG. 3, there is illustrated the external features of an alternative embodiment of our inventive cellular/wireless telephone, the un-mobile telephone 300. Telephone 300 also includes a base unit 268 and a handset 269. It is intended and expected that such an un-mobile 300 phone looks and feels like a conventional business or home phone.

In terms of functionality, the un-mobile phone 300 operates in a manner similar to a conventional cellular phone known in the prior art, but with the added ability to generate a dial tone and the further ability to connect to the AC wall supply 256 through an AC-DC adapter 257 and a connector 258 on the base 259. Not specifically shown in FIG. 3 is the battery back-up system which is necessary during power outages.

Base unit 259 includes speakerphone function having a speaker 260 and a microphone 263, a keyboard 264, a display 267, and a soft key panel 266 with soft-keys 265. As can be appreciated, these functions are similar to those described with reference to FIG. 2.

As a result of it being stationary, the base unit 259 connects to the handset 269 through a cord 253 and jacks 254 and 255. In an exemplary embodiment, the handset 269 may contain only the simple functions provided by a microphone 270 and an earpiece (receiver) 276. This simple version of handset is herein called a type-4 handset. Because the un-mobile phone 300 as depicted in FIG. 3 operates only as a cellular phone, it only incorporates a single antenna 269 at its base 259.

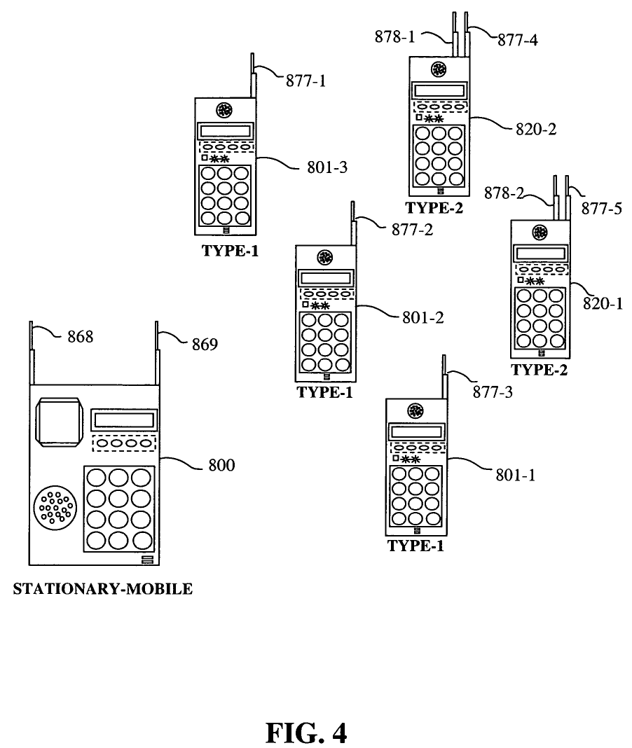

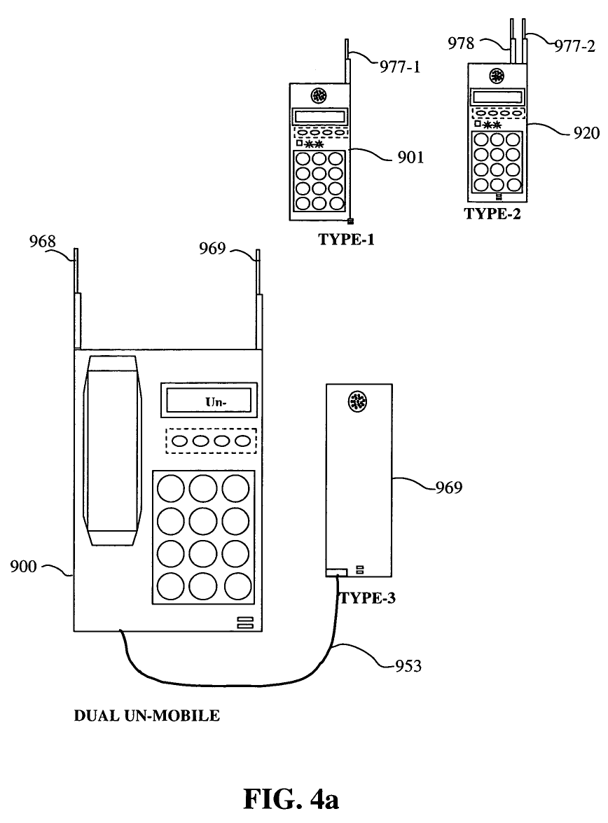

Turning our attention now to FIG. 4, there is illustrated how the base 800 of a stationary-mobile-telephone can be used with multiple handsets 801-1 . . . 801-3; and 820-1 . . . 820-2. As shown in FIG. 4, base 800 includes two antenna systems 868 and 869, one for each mode of operation, cellular and cordless respectively.

As depicted in FIG. 4, handsets 801-1, 801-2 and 801-3 are type-1 handsets, meaning that they only communicate via cordless methods and as such utilize a single antenna 877-1, 877-2 and 877-3 respectively. Handsets 820-1 and 820-2 are type-2 handsets and as such they utilize both cellular and cordless methods and therefore include two antenna systems 877-4 and 878-1 in handset 820-2 and two antenna systems 878-2 and 877-5 in handset 820-1. However, it should be noted that a single antenna system for use in type-2 handsets 802-1 and 820-2 is contemplated if the frequency of operation of the cellular sub-system is sufficiently close in spectrum to the cordless frequency operation such that a single antenna system can serve both frequency sets.

An important characteristic of my inventive telephone depicted in FIG. 4 is the simultaneous use of multiple handsets. For example, and with continued reference to FIG. 4, when a wireless call is active at the stationary-mobile base 800 such that it is communicating with a cellular base station (not shown) servicing the particular cell in which the stationary-mobile base 800 is situated, multiple users can be on that same call using type-1 or type-2 handsets, all automatically configured to operate in cordless mode and communicating with the cordless sub-system within the base. Furthermore, if a user in the same business office or household has a need to get on a different call, any of the type-2 handsets 820-1 or 820-2 can be switched to cellular mode manually using its own cellular telephone number—which is in this case is different from the cellular telephone number of the base 800. When any of the type-2 handsets moves sufficiently away form the base, where the cordless RF signals are out of useful signal reach, the type-2 handsets may automatically switch to a cellular phone with their own telephone numbers unless the user has disabled this feature.

Further features and advantages of our inventive telephone and method can be understood with reference to FIG. 4a where it is shown how base 900 of a dual un-mobile-telephone can be used with three types of handsets. As shown in FIG. 4a, the base 900 has a provision for two antenna systems 968 and 969, one for each mode of operation, cellular and cordless. As can be readily appreciated, the dual un-mobile-telephone includes aspects of our inventive stationary-mobile and un-mobile telephones described earlier in FIGS. 2 and 3 respectively.

With specific reference to FIG. 4a, a type-3 handset 969 is attached to base unit 900 by a cord 953 which operation is as described during the discussion of FIG. 3. Handsets 901 and 920 are type-1 and type-2 handsets. Since handset 920 is a type-2 handset, it contains contain both cellular and cordless sub-systems and it incorporates two antenna systems 977-2 and 978. Conversely, handset 901 contains only a cordless sub-system and therefore only requires the cordless antenna system 977-1. The communication between the base 900 unit and the handsets 901 and 920 is as described during the discussion of FIG. 4 for the stationary-mobile base unit and the type-1 and type-2 handsets shown therein. Lastly, and although in this FIG. 4a only one type-1 and one type-2 handsets are shown, other combinations are also possible and contemplated.

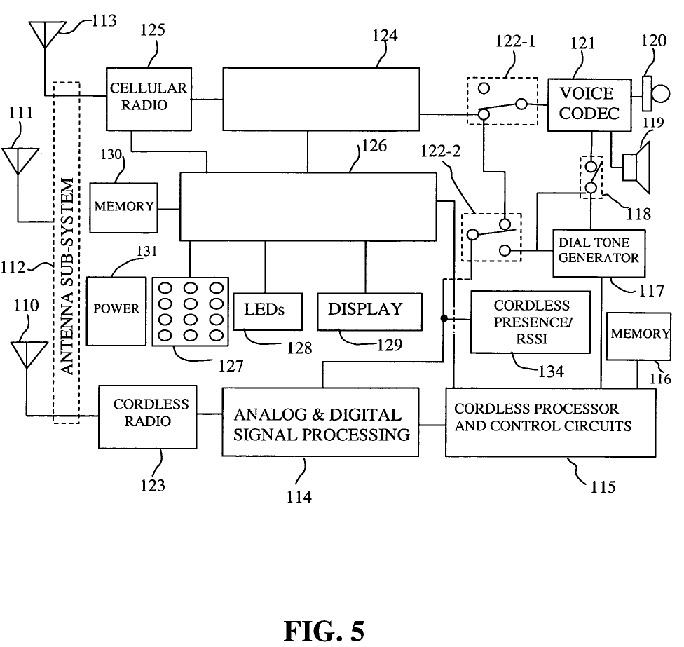

We now turn our attention to FIG. 5, which shows a block diagram of our inventive telephone and in particular the base portion of a stationary-mobile-telephone system or, similarly, the base of the dual un-mobile telephone. At a high level, the block diagram shows two complete sub-systems, a cellular sub-system and a cordless sub-system, along with functions shared by both sub-systems. Of course, it should be noted that each block in FIG. 5 could be made up of more than one integrated chip (IC). Alternatively, the multiplicity of functional blocks could be integrated onto a smaller number of physical integrated circuits, depending upon specific implementation choices.

With continued reference to that FIG. 5, the cellular sub-system shown therein includes: antenna 113, cellular radio block 125 which includes RF receiver and transmitter (not shown separately), analog & digital block 124 which performs such functions as Analog-to-Digital (A/D) conversion, digital-to-analog (D/A) conversion, digital signal processing, radio control and interface and other. In a typical embodiment, radio block 125 along with the antenna 113 provide the functions necessary to transmit and receive RF signals to and from a wireless/cellular base station servicing the cell where the stationary-mobil or dual un-mobil base unit is located. As can be readily understood, radio 125 and the entire cellular sub-system may comply with any or multiple of the most widely available wireless standards today including CDMA, GSM, TDMA, WCDMA, AMPS PHS, PDC, PHS and their derivatives which operate in the spectrum allocated for cellular telephony, generally, 800 MHz, 900 MHz, 1800 MHz and 1900 MHz—depending on the standard. Additionally, cellular sub-system includes master microprocessor 124 (□P) & control circuits 126 which collectively control the major and functions and state of the telephone. Memory 130, which could be comprised of both RAM (Random Access Memory) and Flash Memory (Read and Write non-volatile memory), is used to store program software code and/or other user defined or code defined parameters necessary for operation. Lastly, □P 126 may also control the user interface functions namely, key matrix 127, LEDs 128, LCD 129 and voice codec 121 (Coder-Decoder). As is known in the art, codec 121 is used to encode voice signals and thereby convert audio signals to their digital form and vice versa so that they can be processed by the signal processor, 124.

With continued reference to FIG. 5, the cordless sub-system shown therein comprises functional blocks similar to those in the wireless/cellular sub-system namely, radio 123 and antenna 110 which transmit and receive cordless frequency RF signals to and from type-1 (801-1, 801-2 and 801-3) and type-2 (820-1 and 820-2 handsets). Of course, radio 123 operates in that portion of the electromagnetic spectrum allocated for cordless communications of which the most widely frequencies used are 46/49 MHz which primarily use FM modulation and 900 MHz, 2.4 GHz or 5.8 GHz which primarily use digital frequency hopping modulation.

At this point it is important to note that my inventive telephone is not limited to the use of cordless links such as those identified above, but advantageously, other links such as 802.11 (wi-fi), bluetooth, or wireless infrared would suffice as well.

Returning now to FIG. 5, the cordless sub-system also includes analog & digital processing functions 114 and slave μP & control circuits 115, which while it controls and provides programming in the cordless sub-system, acts as a “slave” in the two-μP overall system. Along with the μP 115 is its associated memory 116 which stores program code and parameters associated with cordless operation.

The functional systems shown in FIG. 5 which are common to both cellular and cordless sub-systems comprises the power supply 131 which includes a battery (not shown) and circuitry associated with the AC-DC adapter 157 shown in FIG. 2. Additional common elements include an optional microphone 120 and optional speaker 119 are shown for those embodiments of my inventive telephone that utilizes a hands-free speakerphone. Audio (analog) switches 122-1,122-2 and 118 route audio signals to either the base's built-in speakerphone or to the handsets via the cordless subsystem. Antenna sub-system 112 is employed when the frequencies of operation of the two sub-systems, the cellular and cordless, are close enough that a single antenna 111 can serve the two sub-systems. When used, antenna sub-system 112 combines or splits RF signals using RF switches and RF filters (not shown). Of particular importance to my inventive telephone is the dial tone generator 117, which generates a dial tone in response to a user's initiation of a call. The cordless-presence system 134, contains specific coding information that indicates to either μP (115, 124) whether any handset of type-1 or type-2 is/are within effective range of the base's cordless sub-system.

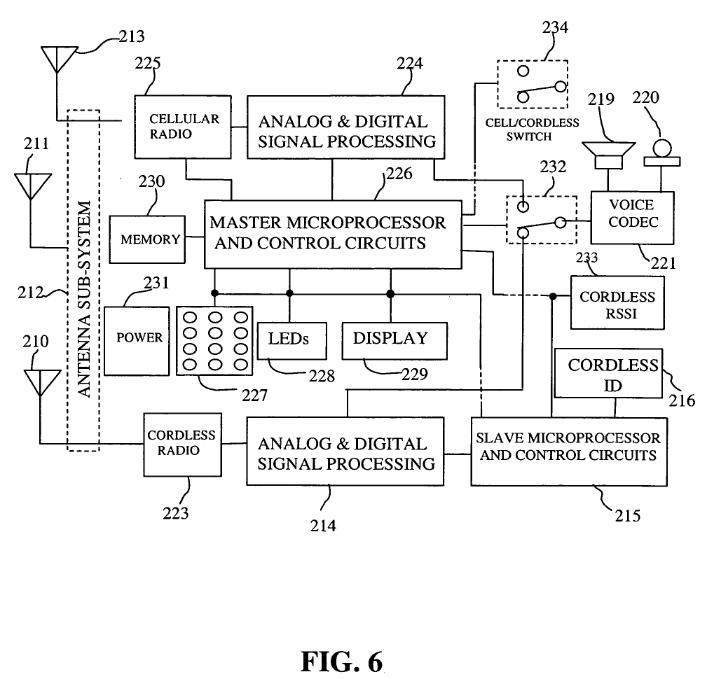

During an active telephone call both the cellular and cordless sub-systems of FIG. 5 are active simultaneously. Special design considerations prevent interference between the two radios 123 and 125 and the two antenna systems 110 and 113. In the receive direction of a voice call, the associated signal is directed from the base station to the cellular antenna 113, processed and routed through the cellular sub-system's receiver and directed to the cordless sub-system's transmit path where it is sent via the cordless antenna 110 to a type-1 or type 2 handset's cordless receiver sub-section (225 in FIG. 6) where it is eventually routed to an earpiece (219 in FIG. 6).

With simultaneous reference now to FIG. 5 and FIG. 6, in the transmit direction, a voice signal begins at a handset's microphone 220, is processed and routed to the transmit section of the handset, sent out the handset's antenna 210, received then by the base's cordless antenna 110 (FIG. 5) processed and routed by the cordless sub-system receiver and routed to the transmit circuitry of the base's cellular sub-system where it is send out via cellular antenna 113 to the cellular base station communicating with the cellular sub-system of the telephone. If the base speakerphone is active, that is, microphone 120 and speaker 119 are on, the cordless sub-system of the base is in standby mode thus preventing the signal from being routed to any handset.

With reference now to FIG. 6, there is shown a block diagram of my inventive type-2 or alternatively a handset which contains both cellular and cordless functions (duocell). The telephone shown in FIG. 6 includes two complete sub-systems, a cellular and a cordless, with some components shared by both sub-systems. The cellular sub-system includes an antenna 213, cellular radio system 225 which includes RF receiver and transmitter (not shown separately), and analog & digital system 224.

When a type-2 or duocell handset such as that depicted in FIG. 6 is in cellular mode, it function as a stand-alone cellular telephone. Before beginning my discussion of this FIG. 6 however, it is important to note that a duocell telephone according to my inventive teachings is NOT associated with a base unit however the functional blocks depicted in FIG. 6 are nevertheless applicable. Accordingly, references made to a base unit in the remainder of this FIG. 6 description is not applicable to the duocell telephone. Additionally, the software programming of the duocell telephone is slightly different form that of the type-2 handset and it is described later.

Advantageously my inventive type-2 handset may be switched manually to a desired mode of operation—either cellular or cordless—through the action of Cell/Cordless switch 234. Radio block 225 in conjunction with antenna 213 transmit and receive RF signals to and from a cellular/wireless base station servicing the cell where the type-2 handset is located. As with the cellular sub-system in the base described with reference to FIG. 5, the radio 225 and the cellular sub-system may comply with any or a mix of the most widely available wireless standards. In addition, the cellular sub-system of a type-2 handset includes microprocessor (□P) & supporting control circuits 226 which controls the major functions and state of the type-2 handset when in cellular mode, a memory 230, which may include both RAM (Random Access Memory) and Flash Memory (Read and Write non-volatile memory), that stores the program software code and other user defined or code defined parameters. The □P 226, when in cellular mode, controls the user interface, key matrix 127, LEDs 128, LCD 129 and voice Codec 221 (Coder-Decoder).

When not in cellular mode (cordless mode), the cordless sub-system takes over operation of the type-2 handset while the cellular sub-system enters standby mode. As shown in FIG. 6, the cordless sub-system includes radio 223 and antenna 210 which transmit and receive cordless frequency RF signals to and from a cordless base (not shown). As is known in the art, radio 223 operates in the'spectrum allocated for cordless communications and is not limited to common cordless frequencies, but could also use other known links such as 802.11, Bluetooth or others. Other elements of the cordless sub-system include analog & digital processing system 214, and cordless □P & control circuits 215.

Functional systems shown in FIG. 6 and which are common to both cellular and cordless sub-systems include power supply 231, microphone 220 and earpiece 219. An audio (analog) switch 232 routes the audio signal to the common codec 221. In operation, the audio signal originates either from the cellular or cordless sub-system. The antenna sub-system 212 is optional and a matter of design choice is used when the frequencies of operation of the two sub-systems, the cellular and cordless, are close enough that a single antenna 211 can be used for both wireless and cordless communications thereby eliminating the need for two separate antennas for each of the two sub-systems. Since the simultaneous operation of cordless and cellular sub-systems ever takes place, the antenna sub-system 212 is simplified.

Importantly, cordless RSSI system 233 evaluates the signal strength from the base to the handset to determine whether it is appropriate to switch from cordless to cellular operation. In particular, when a handset such as that shown in FIG. 6 is moving geographically away from a cordless base station, the RSSI system continually evaluates the signal strength between the base and the handset. If the cordless signal strength falls below a pre-determined, acceptable level, the RSSI system 233 automatically switches the handset into cellular/wireless mode. Lastly, cordless ID system 216 provides a unique identifier for the handset which is typically defined at time of manufacture.

During an active telephone call while in cellular mode, a type-2 handset such as that shown in FIG. 6 functions like a conventional cellular telephone communicating with a cellular/wireless base station servicing the cell where the type-2 handset is situated. Alternatively, when in cordless mode, the receive signal path begins at a base's cellular antenna (113 in FIG. 5), processed through the receive circuits of the base's cellular sub-system routed to the base's cordless sub-system and transmitted via the cordless antenna in the base. The signal is then received at the cordless antenna 210 in the type-2 handset, processed by radio 223 and signal processing system 214 and then routed to earpiece 219. In the transmit direction, a voice signal originates at microphone 220, is processed and routed to the transmit section of the handset 214, 223, transmitted via antenna 210, and subsequently received by the base station's cordless antenna (110 in FIG. 5). The signal is then processed and routed by the cordless sub-system's receiver (123 and 114 in FIG. 5), routed to the transmit circuitry of the base's cellular sub-system (124 and 125 in FIG. 5), where it is send out via cellular antenna (113 in FIG. 5) to the cellular/wireless base station communicating with the cellular sub-system of the handset.

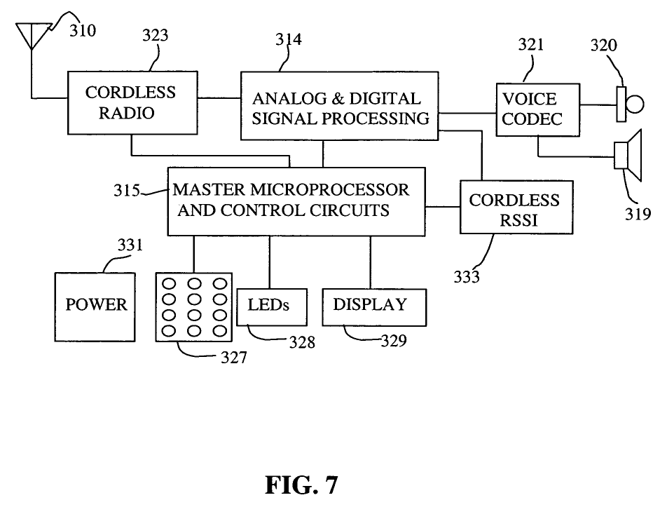

With reference now to FIG. 7, there is shown a block diagram of my inventive type-1 handset. As can be readily observed by inspection of that FIG. 7, the type-1 handset includes a cordless system but not a cellular/wireless system. In a representative application, such a handset is active when the user selects this specific handset to originate or receive a telephone call.

As can now be appreciated, a type-1 handset functions in a similar manner to the cordless sub-system of a type-2 handset. Major functions provided in a type-1 handset include: radio 323, antenna 310 where RF signals are received and transmitted from and to the a stationary-mobile-telephone cordless sub-system. Radio 323 operates in the spectrum allocated for cordless communications of which the most widely frequencies used are 46/49 MHz primarily using FM modulation and 900 MHz, 2.4 GHz or 5.8 GHz primarily using digital frequency hopping modulation.

Shown also in the cordless system of type-1 handset is analog & digital processing system, 314, μP & control circuits system 315, which programs and controls all functions in the cordless system. As should now be apparent, the □P controls the keypad 327, LEDs 328 and display 329. Codec 321, microphone 320, earpiece 319 and power supply 331 perform the same or similar functions as those described earlier during the discussion of the type-2 handset. Similarly, signal and voice paths, whether in the transmit or receive direction, are routed in a manner described previously.

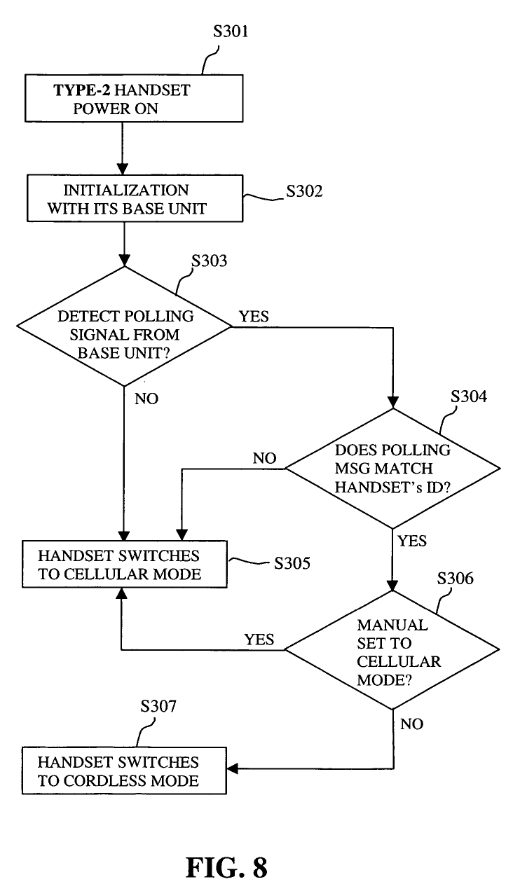

With the functional elements of my inventive telephone described, it is now appropriate to focus on the logical operation of my invention. With reference now to FIG. 8, there is shown a flow chart that illustrates major steps performed by software within the a base or a type-2 handset is automatically switched from cellular to cordless modes and vice versa.

Specifically, step S301 begins after a type-2 handset is turned on, and an initialization routine step S302 subsequently begins between the handset and a base of the stationary-mobile-telephone. During this initialization, the handset transmits to the base its unique ID, and a unique serial number stored in the handset's flash memory. The base records and stores the IDs of all handsets, whether type-1 or type-2, associated with it. After synchronization and initialization is established, the base begins sending messages out sequentially, called polling, in cordless frequencies alternating between the various IDs established during initialization. These polling messages may be sent out every 10 seconds or so.

Each type-2 handset monitors, at step S303, the polling messages from the base and if one matches the handset's own ID at step S304, the handset remains or switches to cordless mode unless the type-2 handset is forced manually into cellular mode at step S306. Although not shown in the flow chart, the handset replies back to the base with its ID number.

If, at step S304, a polling message is not detected or does match the handset's own ID, the handset switches to cellular mode and start operating as a cellular telephone while the cordless sub-system in the type-2 handset goes into standby mode.

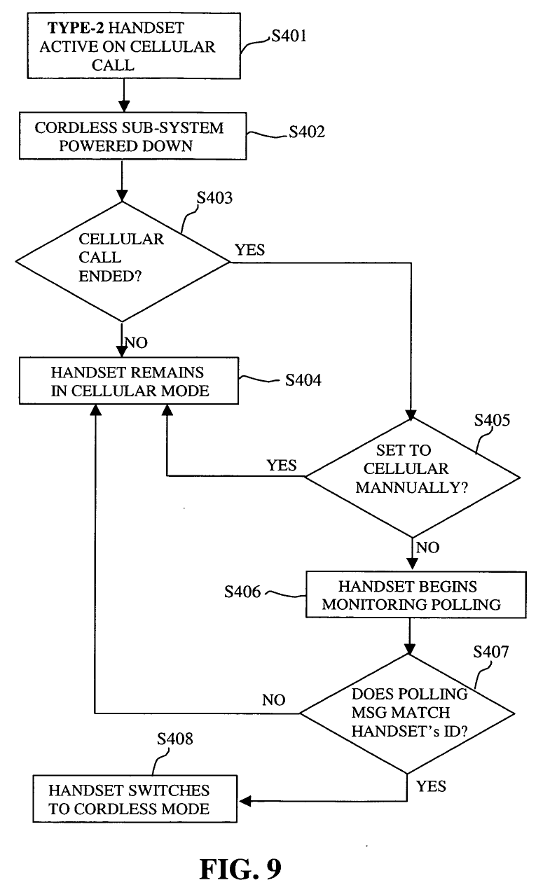

FIG. 9 is a flow chart depicting an extension of the flow chart shown in FIG. 8 and illustrates a scenario when a type-2 handset is in cellular mode while approaching the residence or business office where its base is located.

As shown at step S401, the type-2 handset is in an active cellular call and as described in FIG. 8 its cordless cub-system is in standby mode, step S402, but still detecting polling messages. Regardless of its proximity to its base as shown at step S403, the type-2 handset remains in cellular mode for as long the wireless call is active as shown at step S404.

If the type-2 handset had been set to cellular mode manually using cellular/cordless switch, as shown at step S405, polling/monitoring by the handset is terminated. Once the manual cellular/cordless switch is in the automatic position, the type-2's cordless sub-system begins monitoring the polling messages from the base as shown at step S406.

If, as determined at step S407, a poling message is received by the type-2 handset containing its own ID as described earlier in FIG. 8, the handset switches automatically to cordless operation and communicates with the base's cordless sub-system.

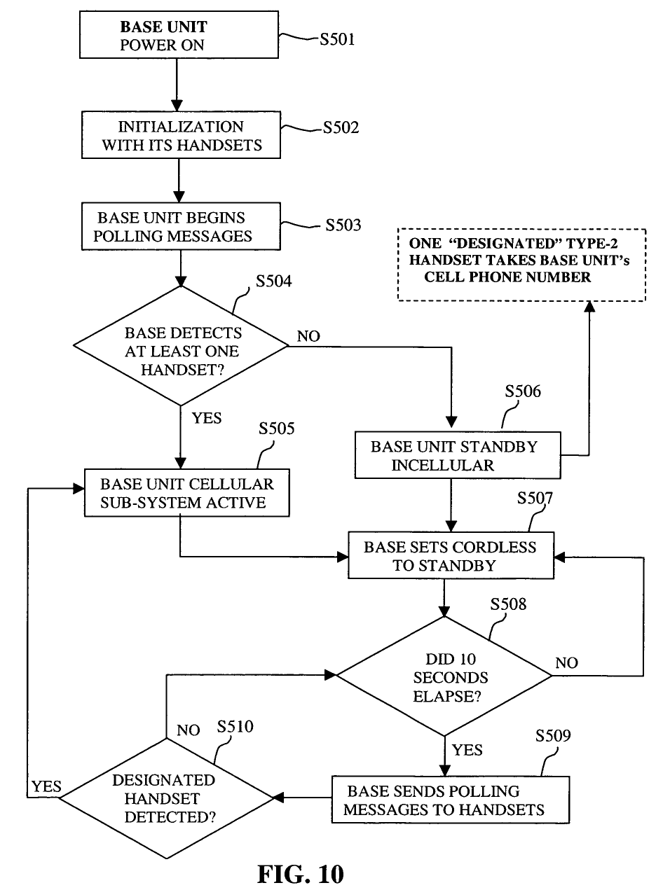

FIG. 10 is a flow chart according to the present invention that illustrates a method of assigning the same telephone number to two cellular phones. In the context of the earlier described embodiments, a cellular sub-system of a base (700 of the stationary-mobile-telephone shown in FIG. 2) may serve as the first cellular phone while the cellular sub-system of the type-2 handset (701 also shown in FIG. 2) may serve as the second cellular phone for the purposes of our example.

Specifically, and with reference to FIG. 10, Initialization and synchronization with the handset is performed at step S502 after the base is powered on at step S501. Such initialization is the generally the same as that described during the discussion of FIG. 8. Subsequently, at step S503, the base begins sending the polling messages (in cordless mode) from which it is expected to receive a reply from each of the handsets provided the handsets are in sufficiently close proximity such that they fall within range of the cordless frequency transmission and reception.

At step S504, a determination is made whether at least one handset is detected by the base, whether type-1 or type-2, the base's cellular sub-system remains active as shown at step S505 i.e., the cellular sub-system of the stationary-mobile-telephone is listening to incoming paging from the base station.

If, at step S504, no handset is detected by the base, the base shuts down its cellular sub-system at step S506 and sets its cordless sub-system to standby mode at step S507. Provided that a “designated” type-2 handset is assigned the exact same phone number by the wireless service provider as that assigned to the cellular sub-system in the base, this “designated” type-2 handset, which also detected the absence of its base as described in FIG. 8, had converted to cellular mode with the same telephone number.

As shown in step S508, the cordless sub-system in the base wakes up and sends polling messages to its handsets at step S509. If and only if the “designated” type-2 handset returns to the base as shown at step S510, only then does the base re-activates its cellular sub-system at step S505.

As can now be appreciated, the above method ensures that only one of the two cellular sub-systems—either the base or the type-2 handset—is operational at any given time thereby effecting the assignment the same phone number to two cellular phones.

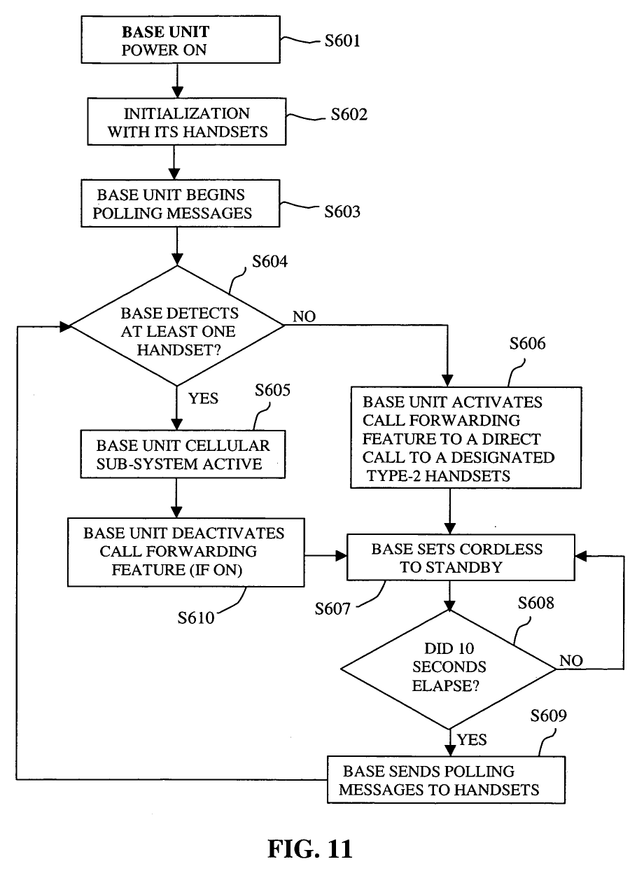

Turning our attention now to FIG. 11, there is shown a flow chart which illustrates an alternative method of assigning the same phone number to two cellular phones, according to my inventive teachings. As was the case before, the two cellular telephones for our illustrative purposes may comprise the cellular sub-system of the base and the cellular sub-system of the type-2 handset.

Initialization and synchronization with the handset begins at step S602 subsequent to the base being powered on at step S601. The initialization is the generally the same as that described previously with respect to FIG. 8, i.e., during initialization, the handset transmits its unique ID, a unique serial number stored in the handset's flash memory to the base. The base records and stores the IDs of all handsets, whether type-1 or type-2, associated with it.

After synchronization and initialization is established, the base begins sending messages out sequentially, polling, in cordless frequencies alternating between the various IDs established during initialization. The base begins sending the polling messages (in cordless mode) at step S603 and expects to receive a reply from each of the handsets provided the handsets are in sufficiently close proximity and within effective range of the cordless frequency transmission and reception.

If, at step S604, at least one handset is detected by the base, whether type-1 or type-2, the base's cellular sub-system remains active as shown at step S605 i.e., the cellular sub-system of the base of the stationary-mobile-telephone it is listening to incoming paging from the base station.

Conversely, if, at step S604, NO handset is detected by the base, the base automatically activates its call forwarding feature, as shown at step S606, to direct the call to a “designated” type-2 handset. It should be noted that in this case the base's cellular sub-system has a different phone number from the handset's cellular sub-system. If the base's cellular sub-system is active or the designated type-2 handset returns to the base, the base de-activates the call forwarding feature as shown at step S610.

Returning now to step S606 where the base activated its call forwarding feature, in the absence of any handsets near the base, the base also set its cordless sub-system in standby mode step S607. Every 10 seconds or so (step S608) the base then sends polling messages (step S609) to the handsets and if any are detected at any given time, the base de-activates its call forwarding feature.

Advantageously, the call forwarding feature can be set manually by the user to direct the call to any type 2 handset (or any phone number for that matter). Additionally, the above method for automatic call forwarding can be disabled by the user, if desired.

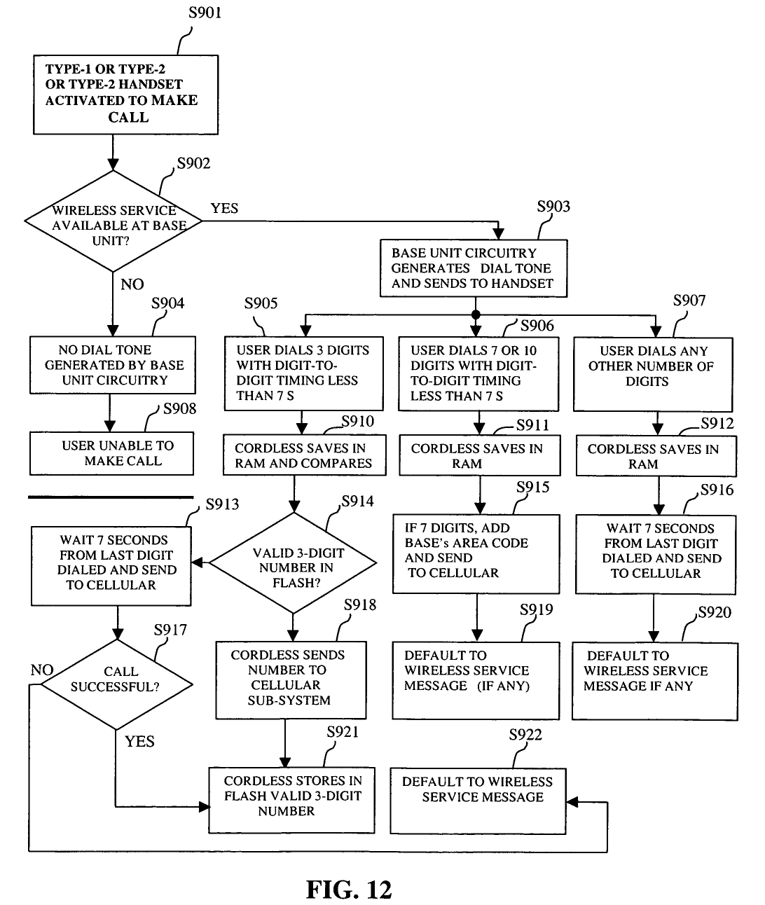

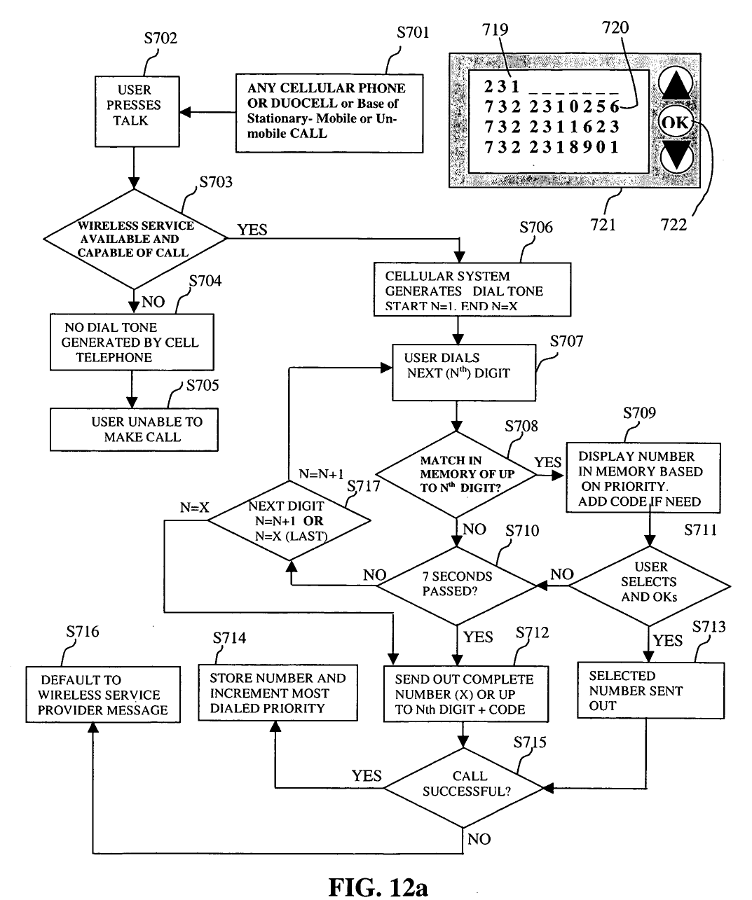

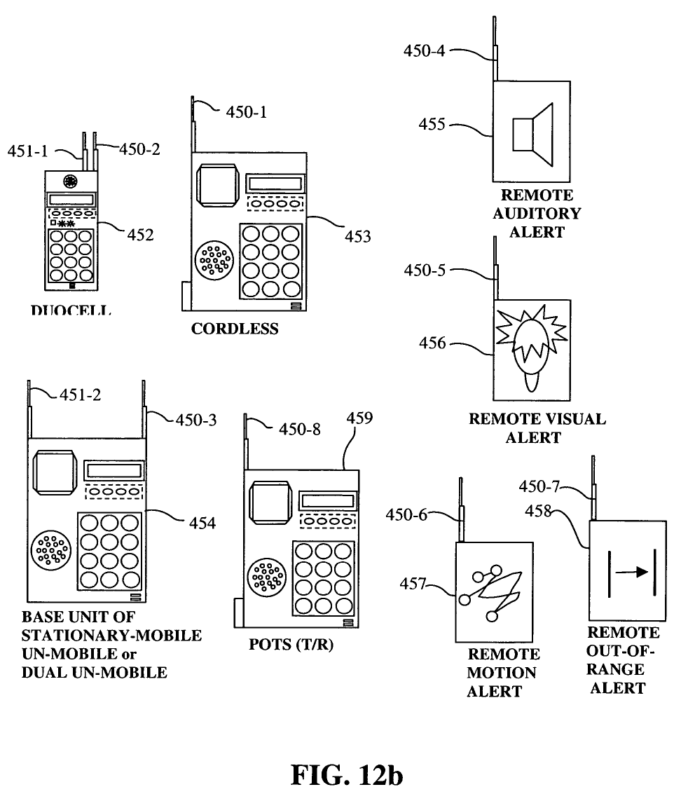

FIG. 12 illustrates in flow chart format a method depicting how a cellular telephone of virtually any wireless technology (GSM, CDMA . . . ) can generate a cell tone (dial tone) according to my inventive teachings. Since this application is more practical in cellular telephones used in fixed locations and for simplicity of explanation, the description of FIG. 12 only makes reference to the stationary-mobile-telephone and the un-mobile telephone systems. It should be noted, however, and as can be readily appreciated by those skilled in the art, that this method is applicable to any cellular telephone system including the dual un-mobile and duocell telephones.

Because both, the stationary-mobile and un-mobile telephones are expected to be stationary, the generation of cell tone is an important aspect of my inventive concepts since it provides a user with the perception that he/she is using a landline phone (POTS) while in actuality wireless service is being used. The physical look and feel of an un-mobile or stationary-mobile telephones also contributes to the perception that a wireline/landline service is being employed. Consequently, throughout the rest of the description of FIG. 12, the term “base” will refer to the base of the un-mobile or stationary-mobile telephones.

With reference now to that FIG. 12, at step S901 a user is getting ready to dial a number either by lifting the type-4 handset of the un-mobile, depressing the “talk” button of a type-1 or type-2 handset or by pressing the “speakerphone” button of the un-mobile or stationary-mobile telephones. While not shown specifically in the earlier described FIG. 2 and FIG. 3, “talk” and “speakerphone” buttons are generally known in the art and as such could be readily implemented in the configuration(s) shown in those FIGS.

At step S902 the cellular sub-system of the un-mobile or stationary-mobile bases determines whether there is wireless service available in the area i.e., whether the telephone has adequate reception of the RF signals from the nearby base station. Received signal strength measurements and digital signal processing at step S902 determine whether the cellular sub-system is capable of initiating a call. If no wireless service is available or no outgoing call capability is determined, no cell tone is generated as shown at step S904 and the user is unable to make a call as shown at step S908.

If, at step S902, wireless service is available AND the received signal strength from the base station and signal processing indicate that a call is possible, the cell tone is then generated at step S903 by the base's internal circuitry i.e., block 117 in FIG. 5 and then sent to the type-1 or type-2 handsets via the cordless link or through the speaker of the base if speakerphone operation is selected or a type-4 handset is being used.

According to one aspect of my inventive concepts, when the user dials a number, the digits are NOT automatically sent one by one to the cellular sub-system of the base. Instead, they are stored in RAM by the cordless sub-system of the base as shown at steps S910, S911 and S912 until the user is done dialing.

By way of example, if the user dials a 3-digit number such as 911 or 411, the base (cordless sub-system) compares—at step S914 to—determine whether this 3-digit number is valid i.e., all known valid 3-digit numbers reside in Flash memory. If the 3-digit number dialed is valid, the cordless sub-system sends the number, at step S918, to the cellular sub-system which, in turn, is dialed out to the wireless network.

On the other hand, If the 3-digit number dialed is not a match with the valid 3-digit numbers contained in Flash memory, the cordless sub-system waits for substantially 7 seconds as shown at step S913 and then again sends the dialed number to the cellular sub-system. As determined at the next step, step S917, if the call is successful, the dialed 3-digit number becomes a valid number and is stored in Flash memory at step S921 to be used for future 3-digit comparisons. If the call is not successful, the cellular sub-system defaults to the message received from the wireless network as shown at step S922. As can be appreciated, the telephone according to my inventive teaching, “learns” which 3-digit numbers are in fact valid.

Returning now to the flow chart of FIG. 12, at step S906, if a 10-digit number (area code+7 numbers) is dialed after the cell tone is generated at step S903, the number is again stored temporarily in the base's cordless sub-system at step S911 and then send to the cellular sub-system at step S917 which in turn sends the number to the wireless network and then defaults to the result form the network at step S919.

If, at step S906, a 7-digit number is dialed by the user, the cordless sub-system base adds its own area code (the cordless sub-system knows the cellular sub-system's own phone number) at step S915 and then sends the number to the cellular sub-system and then defaults to the wireless network at step S919. As can be appreciated, such a feature eliminates the need for a user to enter area codes in the local area, thereby relieving the user from necessarily providing such information.

Continuing, if any other number of digits is dialed (other than 3, 7 or 10) as shown at step S907, the cordless sub-system of the base saves the number in RAM (step S912) and then sends the number to the cellular sub-system after a delay of substantially 7 seconds as shown at step S919 and then defaults to the wireless network at step S920. Although not specifically shown in the flowchart of FIG. 12, after step S916, if a successful call was completed, the dialed number is stored in flash for future comparison such that the substantially 7 second delay is eliminated. Likewise and again not shown in the flowchart, at step S915 after the addition of the cellular sub-system's area code to the 7-digit dialed number, if the call is successful the 3-digit local exchange number (ex. 555 in 555-1212) is stored in Flash for future numbers dialed. Finally, it should be mentioned that the substantially seven (7) second delay described above is variable and is chosen here for example. If, more desirable delay, either longer or shorter is determined to be useful as a result of human factors or other considerations, our inventive method can be modified to provide such longer or shorter delay.

With reference now to FIG. 12a, there is illustrated an alternative method of generating cell tone (dial tone), when a traditional cellular is used, along with automatic completion of a partially number being dialed, the elimination of the “send” button and the automatic insertion of the area code or other prefix if the phone is used in countries other than the US. Each of these capabilities would reinforce the user's perception of having a wireline connection whereas in actuality cellular telephony is being used. These features are particularly important in fixed location cellular telephones systems such as the stationary-mobile, un-mobile or the dual un-mobile telephones. It should be pointed out that the two features of automatic completion of a partially dialed number and the elimination of the need to include the area code (n certain cases) are not limited in cellular telephone applications but also in all telephones including T/R analog wireline, ISDN, cordless or any other interface wired or wireless.

With reference now to FIG. 12a, there is shown a flow chart depicting my inventive method of operating a wireless/cellular telephone. To summarize the inventive method depicted in FIG. 12a, a dial tone is generated when the cellular telephone determines that a sufficiently strong RF signal from the nearest base station (BS) is present. As a user dials digits, the cellular telephone's software determines whether the dialed digits and their relative position match any digits of a number corresponding to a previously and successfully made call which is already stored in the memory of the cellular telephone. If a match is made, the matching number is completed automatically by the telephone and displayed. If more than one match is found in memory, the matched numbers are displayed according to a pre-defined priority—i.e., based on their history of most often called. The user may then select the number of choice with a specific arrow button. If no match is found, the number the user dials is sent out to the wireless network substantially 7 seconds (again, variable depending upon human factors) after the last digit of the number is dialed. If this call is successful, the number—including its area code—is stored in memory for future use.

As can be appreciated, this inventive method may be adjusted to accommodate different prefixes for different countries as it has the ability to “learn” numbers and prefixes. Regardless of the number of digits dialed, the cellular telephone will send out to the wireless network any pre-determined number of digits substantially 7 (or other) seconds from the last digit dialed. Advantageously, this combination of dial tone, timing information and storage of numbers in memory allow for the elimination of the “send” button in cellular telephones.

As can be readily appreciated by those skilled in the art, with cellular telephony as presently implemented, the “send” button is that button pressed after a complete number is dialed including the area code (US or North American Dialing). Because there is no need for a “send” button, only a “talk” or equivalent button is necessary; similar to that of cordless telephones.

With continued reference now to FIG. 12a, step S701 indicates that the device being used is any suitable wireless technology (GSM, CDMA, WCDMA, PHS, PDC, OFDM or other) cellular telephone. As can be appreciated, step S701 includes the fixed location cellular phone systems, stationary-mobile, un-mobile and dual un-mobile described herein, along with the specialized duocell phone.

At step S702, a user gets ready to make a telephone call by pressing the “talk” button or equivalent button of the cellular telephone. At step S703, the digital signal processing (DSP) system of the phone calculates the (BS) base station's RF signal strength to determine wireless service is available and/or usable for the call.

As can be appreciated, in a specific embodiment of the present invention wherein a signal strength indicator integrated into the telephone, the user can determine, visually or otherwise, the possibility of a call origination by assessing the signal strength which is generally a measure of RF signal energy from the nearest BS, although this is not always accurate. If it is determined that a cellular call is warranted, cell tone (dial tone) is generated by the phone's internal circuitry at step S706.

If no wireless service is available in the area or if phone's DSP determines a weak reception of RF energy from the BS, no cell tone is generated as shown at step S704 and the user is unable to make a call as shown at step S705. In this case an error tone is generated by the phone and, in a preferred embodiment, a no-call-possible or equivalent message may be presented to the user, i.e., on the phone's display.

When the dial tone is generated at step S706, a count of 1 is set for a software variable (N) in the algorithm expecting the user to dial the first digit. As the user dials digit after digit, as shown at step S707, the algorithm compares, at step S708, the digits dialed so far to any numbers previously stored in the phone's memory to determine whether there is a match. As noted earlier, the numbers stored in memory are typically those numbers successfully completed in previous calls. Additionally, at step S708, the number being dialed is compared up to the first three (3) digits dialed for any match in both the area code and 3-digit local exchange. If a match is found, the algorithm shows the completed number (s), at step S709, on the phone's display 721.

The number of telephone numbers displayed is a matter of implementation based on several factors such as display (LCD) size, character size, selectable user preference or other. The numbers displayed are shown in order of a pre-determined priority, i.e., the number called the most times in the history of the phone appears first on the list.

With continued reference to the display 721 of FIG. 12a, there is shown a dialing example. In this example, the user only dialed the local exchange number “231” (Ref # 719), without the area code. Because there were no numbers in memory having a “231” area code, the algorithm displayed the complete numbers in memory that matched the local exchange including the area code 720. As shown, if there is match for both local exchange and area code, the area code takes precedence. If there is no history of numbers in memory, no match is found and therefore nothing is displayed. When numbers are displayed, the user has the option to select which number to dial out without pressing the rest of the digits as shown at step S711. The number is then sent out to the wireless network at step S713. If the call is successful, at step S715, the number is automatically stored in the phone's memory, step S714, unless of course it is already in memory. In either case the number's priority is increased by a count of 1 for future comparisons of numbers most often called. If the call does not go through, the phone defaults to the wireless service message and nothing is stored in memory.

Returning our examination with step S708, if the user waits more than substantially 7 seconds to dial the next digit, as shown at step S710, the number of digits dialed up to this point will be sent out to the wireless network and proceed again through steps S715 and S714 to determine if the call was successful and be stored in memory or default to the wireless network message at step S716. If subsequent button presses are less than 7 seconds apart, the algorithm proceeds through step S717 to determine whether enough digits have been dialed (N equals X) to sent the number out without added delay and wait time or to allow the user to proceed pressing the next button as shown at step S707. As noted earlier, the substantially 7 seconds specified herein is only a guide and can be changed as required based on country, specific segment of the population or other factors.

Step S717 provides the telephone with the ability to “learn” telephone numbers. As can be readily appreciated by those skilled in the art, telephone numbers always have a last digit, defined in the algorithm as X. For example, X can be 10 based on the fact the in the North American Numbering Plan, a telephone number consists of a 3-digit area code, a 3-digit local exchange and four other numbers for a total of 10 digits. If a user dials, for example, a 7-digit number without the area code and there is a match in memory including the area code, the algorithm recognizes that and dynamically sets X equal to 7, automatically adds the area code and send out the number, step S712, without any delay or wait time. Furthermore, if a user dials a 7-digit number, again without the area code but there is no such number in memory, the algorithm adds the phone's own area code and sends the number out as shown at step S712. To avoid erroneously dialing out the wrong number, timing information between key presses is also advantageously employed by the algorithm.

Special numbers such as 911 or 411 are recognized by the algorithm at step S717 in conjunction with memory by setting X equal to 3 and sending out the number immediately. This algorithm along with timing information may be varied such that it is “optimized” for a particular implementation. Advantageously, the algorithm is applicable in a cellular system in any country as it can be programmed to accommodate the telephone numbering scheme in that country.

With reference now to FIG. 12b, there is shown how different telephone systems, that include a redundant or secondary radio or air link sub-system, can be used for a multitude of applications. The secondary radio or air link can be of any type including cordless, 802.11, blue tooth, infrared or other. For simplicity, it will be assumed for the remainder of this discussion that the specific implementation utilizes cordless at 2.4 GHz. Reference to a dual function phone for the remainder of this description means any of the telephones systems described herein.

The telephone types shown in FIG. 12b include a duocell 452 which is a cellular telephone having one of a number of wireless technologies such as GSM, CDMA, PDC etc but also includes a secondary radio that uses cordless technology at, for example, 2.4 GHz. Consequently, this phone includes two antenna systems, cordless 450-2 and cellular 451-1. The secondary radio, while redundant is this phone, may advantageously be used to communicated or control some other remote device.

The base unit 454 of the stationary-mobile, un-mobile or dual un-mobile telephone systems is another device that includes both cellular and cordless sub-systems along with cellular and cordless antenna systems 451-2 and 450-3 respectively. Although the cordless sub-system in the base unit 454 is intended to communicate with handsets, advantageously it may be programmed such that it can communicate with handsets and control another device.

Also shown in FIG. 12b is a traditional cordless telephone 453, having only a single, cordless antenna system, 450-1. And even though cordless telephone 453 only includes a single radio system and a single antenna system 450-1, it can also be programmed to send different messages—as distinguished from those it sends to its handsets—in order to control other devices. Lastly a wireline Tip/Ring T/R (POTS) telephone may be equipped with a cordless radio sub-system and its antenna 450-8 to communicate with remote devices as well.

One of many applications of these inventive dual function phones is alerting a user of an incoming call in a variety of ways. For example, the remote-auditory-alert 455 may be used in those situations where the user is away from the phone or if the user is hearing impaired. The remote-auditory-alert device 455 may advantageously include the same technology air link as the dual function phone, in this case a cordless system and its antenna 450-4. Software programming and a handshaking algorithm is used in the communication protocol between the remote device 455 and the dual function phone such that the remote device is activated at appropriate times.

Other methods for remote alerting include the remote-visual-alert device 456 having a cordless antenna 450-5 and the remote-motion alert device 457. Remote visual alert device 456 may be used by hearing impaired individuals or in high background/ambient noise environments where visual notification is necessary or otherwise desirable. As can be readily appreciated by those skilled in the art, such a remote visual alert device may employ a blinking light or a more sophisticated array of lighting patterns. Additionally, the motion alert device 457 may be a signaling device that employs a mechanical motion, i.e., a spinning propeller, or other, that can be set in motion by signaling information transmitted from the dual function phone.

Of special interest to my invention described herein is the remote out-of-range alert device 458 which includes a cordless system corresponding antenna 450-7. It can be used in conjunction with the duocell telephone to monitor, for example, a pet or child to ensure they stay within range of the cordless sub-system of the duocell. Specifically, the duocell phone may be programmed such that an alarm or other indicator notifies the user when the device 458 goes beyond the range of RF communication between the two systems. Two duocell telephones can also be used to perform the same function where one of the two is the master (parent's cellular phone) while the other is the slave (child's cellular phone). In this case both phones have the ability to make cellular calls but the master duocell has an alarm activated when the slave duocell goes beyond the range of cordless communication between the two phones.

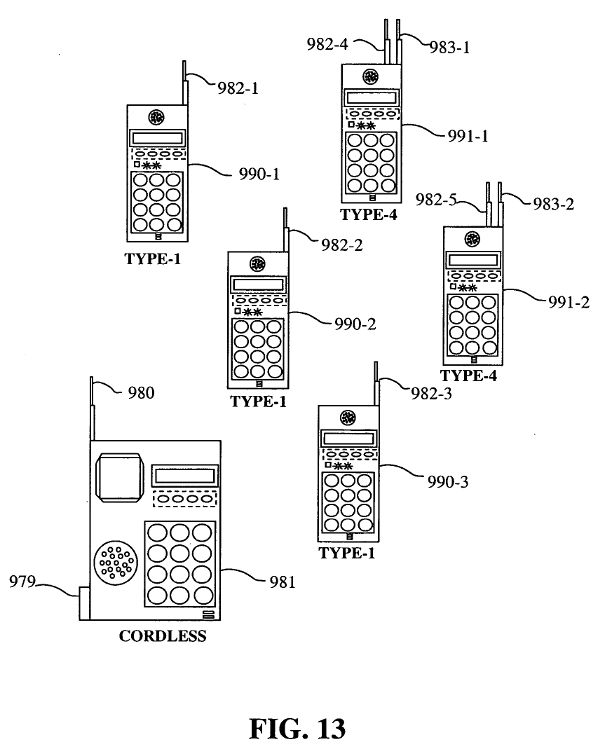

FIG. 13 shows a derivative/variation system of the stationary-mobile-telephone which we may descriptively refer to as a “cellcordless telephone”. Specifically, and with reference to that FIG. 13, the base 981 of the cellcordless phone includes a cordless system and communicates with its handsets using the spectrum and technology allocated for cordless communications such as those described prior. The base of the cellcordless telephone connects to the landline T/R telephone jack ( not shown) through its own phone T/R jack 979. The internal circuit blocks of the base are very similar to those in FIG. 7. The base antenna 980 is designed to operate only in cordless frequencies.

One difference between the cellcordless telephone of FIG. 13 and a cordless telephone is that the cellcordless base includes software and algorithms to perform those inventive functions as were described with reference to FIG. 8 and FIG. 9, that is, the detection of its handsets present. Such detection functions are required, according to my inventive teachings, because the cellcordless phone can interact with standard cordless handsets (type-1) 990-1, 990-2 and 990-3 as well as type-4 handsets, 991-1 and 991-2. As noted before, type-4 handsets are similar to type-2 handsets but only have to interact with a cordless-only base. As such, antennas 983-1, 983-2 and 982-4, 982-5 operate in cellular and cordless modes respectively.

As can be appreciated, and while recalling those methods depicted in FIG. 8 and FIG. 9 those algorithms show there are applicable to the type-4 handset such that it can switch from cordless mode when close to its base or become a stand-alone cellular telephone (with a different number from that of the base) when away from its base 981, as taught by my inventive teachings.

As can now be appreciated the cellcordless phone may advantageously be used in areas where no wireless coverage exists, but the same handset could be used when leaving a residence or an office.

At this point, some additional aspects of my invention become apparent. In particular, a stationary-mobile-telephone having type-2 handsets can be constructed such that when a caller calls a phone number of the base unit, all handsets within a useful range of the base unit as well as the base unit ring (alert). In addition, if the telephone number of a type-2 handset cellular telephone is called, and it is assumed that the type-2 handsets have different cellular phone numbers from that of the base unit and from one another, then only the handset whose phone number is being called will ring.

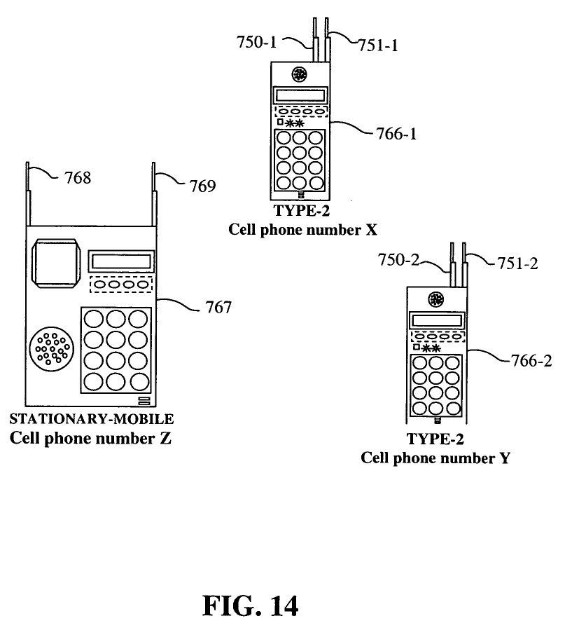

With reference now to FIG. 14., there is shown a stationary-mobile-telephone having a base unit 767 and two type-2 handsets 766-1 and 766-2. Of course, and as can be readily appreciated, any number and combination of type-2 and type-1 handsets is possible. Additionally, and as noted earlier, base unit 767 of the stationary-mobile-telephone has both cellular and cordless sub-systems which communicate via RF signals using antenna systems 768 and 769 respectively. The two type-2 handsets, 766-1 and 766-2, each also include cellular and cordless subsystems that communicate with a serving cellular base station (not shown) via antennas 751-1 and 752-2 and with a base unit via cordless frequency RF signals using antenna systems 750-1 and 750-2 respectively.

When made service operational, the base unit is assigned a distinct telephone number by a serving wireless service provider. Additionally, since the two type-2 handsets 766-1 and 766-2 also include cellular and cordless subsystems communicating with the base unit with cordless frequency RF signals using antenna systems 750-1 and 750-2 when near the base unit, while communicating with nearest base station with cellular RF signals using antenna systems 751-1 and 751-2 when in cellular mode. In this illustration the two type-2 handsets are assigned different and distinct cellular phone numbers, from each other and the base unit.

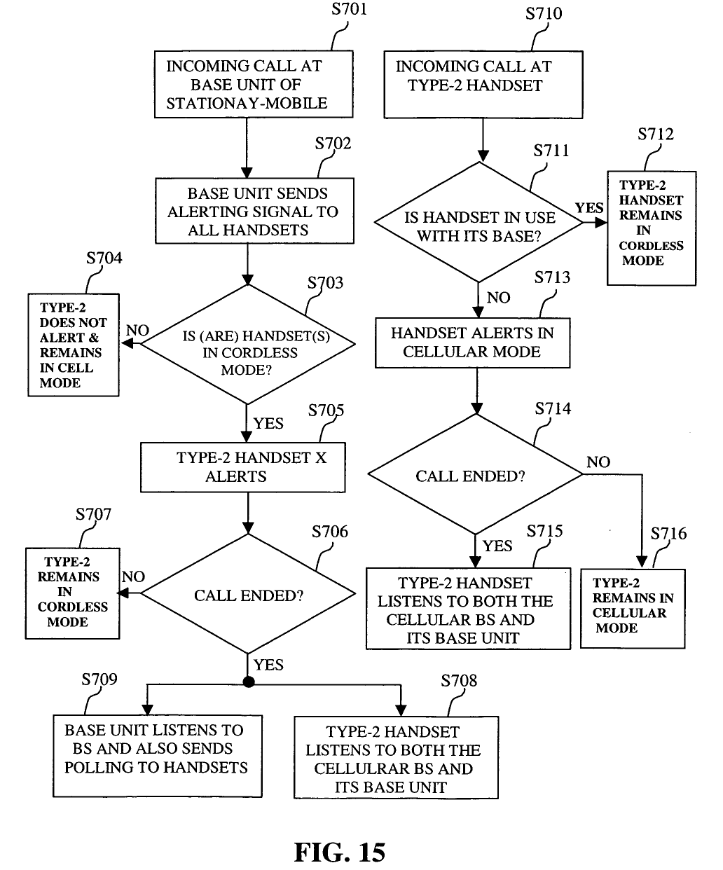

With reference to FIG. 15, there is shown a flow chart depicting how a type-2 handset can be made to alert (ring) when the telephone number of the base unit is called and additionally, when the cellular telephone number of the type-2 handset is called. Continuing with FIG. 15, at step S701 the cellular telephone number Z of the base unit is called. The base unit then sends an alerting signal to all of its handsets at step S702. As shown at step S703, all handsets within reach of RF communication from their base unit receive the alerting signal and activate their ringer at step S705, unless of course the handset has been manually switched to cellular mode or unless the handset is already on an active cellular call as shown at step S704.

The handset (phone number X) now active on the call with its base unit will remain in cordless mode communicating with the base for as long as the call is active, as shown at steps S706 and S707. All other handsets (cell phone number Y) will be available to receive calls in cellular mode at their own phone numbers. When the call ends as shown at step S706, the handset with cell phone number X will alternate between listening to incoming calls from the nearby base station on its own phone number X and listening to polling messages from the base of the stationary-mobile-telephone as shown at step S708. Similarly, when the call ends, the base unit will alternate between sending polling messages to its handsets and listening to incoming calls from the nearby base station for phone number Z as shown at step S709.

Step S710 begins the sequence when a type-2 handset with phone number Y is within RF communication with the base unit of the stationary-mobile-phone but receives a call at its own cellular phone number Y. Assuming that the type-2 handset that receives the cellular call is not already on a call with its base as shown at step S711, in which case it is operating in cordless mode step S712, the alerter associated with this type-2 handset is activated by its cellular sub-system as shown at step S713. If the user answers the call at step S714, the handset will remain in cellular mode for as long as the call is active as shown at step S716 or the user moves away from the base unit. When the call ends, as shown at step S715, the type-2 handset alternates listening between its own base unit for calls to phone number Z as well as listening for incoming cellular calls to its own number Y (from the nearby base station).

A stationary-mobile-telephone, as I have described, has the ability to transfer an incoming call at the base unit to any of the cellular phone numbers of its type-2 handsets when the user does not answer the call and, the wireless service voice messaging system picks up. Advantageously, this is performed through the action of a pre-recorded outgoing voice message that instructs the caller to press a particular number to select which type-2 handset the call should be re-directed to. Of further advantage, the re-directing of the call can be implemented in either the base unit of the stationary-mobile-telephone or within the wireless service provider network.

Alternatively, if the incoming call is answered at the base unit, the person that answered the call can still transfer the call to any of the type-2 handsets by pressing the appropriate button corresponding to that particular type-2 handset. As above, this feature can be implemented either by the base unit of the stationary-mobile-telephone or by the wireless service provider's network provided such service feature is added to the system.

At this point of my discussion, the stationary-mobile-telephone of FIG. 14 with its base unit 767 and its two type-2 handsets 766-1 and 766-2 will be referred to in explaining the re-directing and transfer of calls. Additionally, it is assumed for our my purposes that the user of the stationary-mobile-telephone has pre-recorded an outgoing voice announcement for missed calls to instruct the a caller calling phone number Z to press 1 if the call is to be directed to type-2 handset with phone number X and to press 2 for the call to be directed to type-2 handset with phone number Y. Although the call re-direction here is described in terms of a simple key press, advantageously the actual implementation could involve a sequence of key presses, voice recognition or even existing wireless service provider features such as conferencing.

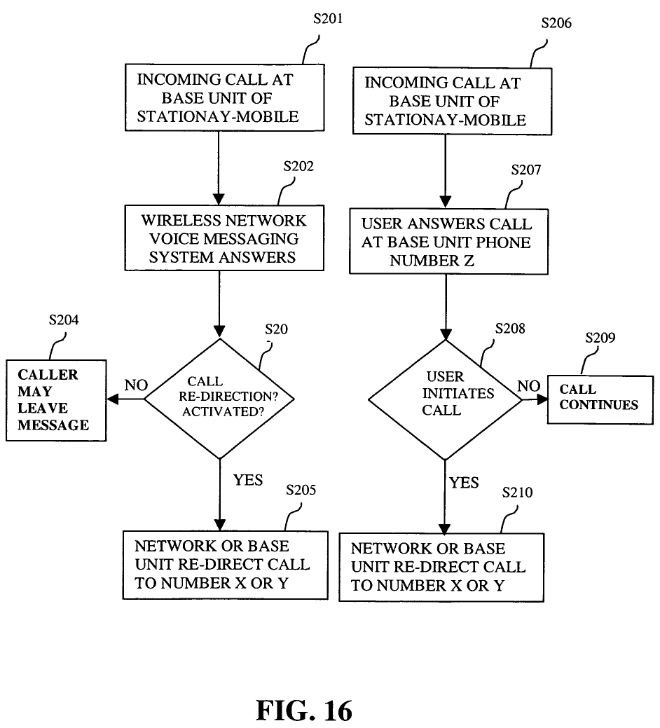

The call redirection scenario may be readily understood with reference to FIG. 16. Specifically, at step S201, the phone number Z of the base unit is being called and because no one answers the call after a prescribed number of rings, the voice messages system of the wireless network initiates at step S202 and instructs the caller, via a pre-recorded outgoing announcement, to follow the prompts for the appropriate action. The owner of the base unit is assumed to have activated the call re-direction feature, step S203, either at the base unit of the stationary-mobile-telephone (if the base unit implements the call re-direction) or with the wireless network (if the service provider implements the call re-direction). If the voice prompts instruct the caller to leave a message then step S204 of FIG. 16 is reached. Otherwise, the caller may press 1, for example, to re-direct the call to cellular phone number X or 2, for example, to re-direct the call to phone number Y for the either of the two type-2 handsets as shown at step S205. As explained above, the instruction prompts for the caller may involve voice recognition or existing network feature instead of simple button presses.

Continuing with FIG. 16, shown therein the scenario of call re-direction after a call is answered. At step S206, the phone number Z of the base unit is being called and a user answers the call, at step S207, either by using the base unit's speakerphone or using one of the two type-2 handsets, for example, the one with phone number X. Advantageously, it is anticipated that the call re-direction feature can be implemented while the user is on a call as well. The owner of the base unit again is assumed to have activated the call re-direction feature and decides to re-direct the call to phone number Y at step S208. If the user took no action to re-direct the call then the call would continue normally as shown at step S209. The call re-direction is more complex during an active call at the base unit and would involve timing information between key presses or other actions taken by the user based on the instruction prompts. At step S210, the base unit or the wireless network, depending on which entity implements the call re-direction, perform the call re-direction to type-2 handset with phone number Y.

Of course, it will be understood by those skilled in the art that the foregoing is merely illustrative of the principles of this invention, and that various modifications can be made by those skilled in the art without departing from the scope and spirit of the invention, which shall be limited by the scope of the claims appended hereto.

1. A telephone system comprising:
a base unit including:
a cellular communications sub-system for providing cellular communications via a cellular service provider; and
a radio communications sub-system for providing radio communications to one or more handsets; and
a dial tone generator for generating an audible indication of cellular service availability;
the one or more handsets including:
a radio communications sub-system for providing radio communications between the one or more handsets and the base unit;
a cellular communications sub-system for providing cellular communications via a cellular service provider; and
a dial tone generator for generating an audible indication of cellular service availability;
wherein the dial tone presented to a user of the one or more handsets is generated by the base unit dial tone generator and transmitted from the base unit to the handset over a radio communication link when the handset is communicating via the base unit and generated by the handset when the handset is communicating via its cellular communications sub-system.

2. The telephone system according to claim 1 wherein the base unit further comprises:
a corded communications sub-system for providing communications to one or more corded handsets; and
the one or more corded handset(s).

3. The telephone system according to claim 2 further comprising:
one or more additional base units each having:
a cellular communications sub-system for providing cellular communications via a cellular service provider;
a radio communications sub-system for providing radio communications to the one or more handsets; and
a dial tone generator for generating an audible indication of cellular service availability.

4. The telephone system according to claim 3 wherein the one or more handsets further comprise:
a communications selector for selecting which communications sub-system—radio or wireless—is to be used for communications.

5. The telephone system according to claim 4 wherein the communications selector is a user-operable manual switch.

6. The telephone system according to claim 4 wherein the communications selector is a communications link analyzer that analyzes characteristics of the radio communications sub-system and the cellular communications sub-system and determines, based upon those analysis, which communications sub-system is used for communications.

7. The telephone system according to claim 6 wherein the analyzed characteristics include a signal strength measurement of the respective communications signals.

8. The telephone system according to claim 1 wherein the cellular communications sub-system communicates according to a cellular communications format selected from the group consisting of: Code Division Multiple Access (CDMA), Wideband Code Division Multiple Access (WCDMA Wideband CDMA), Groupe Special Mobile (GSM), Time Division Multiple Access (TDMA), Advanced Mobile Phone System (AMPS), Personal Digital Cellular (PDC), Personal Handy-Phone System (PHS), Orthogonal Frequency Division Multiple Access (OFDMA).

9. The telephone system according to claim 1 wherein the radio communications sub-system communicates according to a radio communications format selected from the group consisting of: analog 46/49 MHz FM modulation; digital spread spectrum 900 MHz; digital spread spectrum 2.4 GHz; digital spread spectrum 5.8 GHz; 802.11 and BLUETOOTH.

10. The telephone system according to claim 1 wherein the base unit radio communications sub-system provides full-duplex communication.

11. The telephone system according to claim 1 wherein the base unit cellular communications sub-system provides full-duplex communication.

12. The telephone system according to claim 1 wherein the handset radio communications sub-system provides full-duplex communication.

13. The telephone system according to claim 1 wherein the handset cellular communications sub-system provides full-duplex communication.

14. The telephone system according to claim 1 wherein radio sub-system of the base unit and the radio sub-system of a handset communicate via full-duplex communication simultaneously with the base unit being in full duplex communication with a base station using the cellular communications sub-system.

15. A telephone system comprising:
a base unit including:
a means for providing cellular communications via a cellular service provider;
a means for providing radio communications to one or more handsets; and
a means for generating a dial tone as an indication of cellular service availability;
the one or more handsets including:
a means for providing radio communications between the one or more handsets and the base unit;
a means for providing cellular communications via a cellular service provider; and
a means for generating a dial tone as an indication of cellular service availability;
wherein the dial tone presented to a user of the one or more handsets is generated by the base unit dial tone generating means and transmitted from the base unit to the handset over a radio communication link when the handset is communicating via the base unit and generated by the handset dial tone generating means when the handset is communicating via its cellular communications means.

16. The telephone system according to claim 15 wherein the base unit further comprises:
a means for providing communications to one or more corded handsets; and
the one or more corded handset(s);
wherein the dial tone presented to a user of the one or more corded handsets is generated by the base unit dial tone generating means.

17. The telephone system according to claim 16 further comprising:
one or more additional base units each having:
a means for providing cellular communications via a cellular service provider;
a means for providing radio communications to the one or more handsets; and
a means for generating dial tone as an indication of cellular service availability.

18. The telephone system according to claim 15 wherein the one or more handsets further comprise:
a means for selecting which communications sub-system—radio or wireless—is to be used for communications.

19. The telephone system according to claim 18 wherein the means for selecting the communications sub-system includes a user-operable manual switch.

20. The telephone system according to claim 18 wherein the means for selecting the communications sub-system includes:
a means for analyzing characteristics of the radio communications sub-system and the cellular communications sub-system; and
a means for determining, based upon the analysis, which communications sub-system is used for communications.

21. The telephone system according to claim 20 wherein the analyzing means includes a means for measuring the signal strength of the respective communications signals.

22. The telephone system according to claim 15 wherein the cellular communications means communicates according to a cellular communications format selected from the group consisting of: Code Division Multiple Access (CDMA), Wideband Code Division Multiple Access (WCDMA Wideband CDMA), Groupe Special Mobile (GSM), Time Division Multiple Access (TDMA), Advanced Mobile Phone System (AMPS), Personal Digital Cellular (PDC), Personal Handy-Phone System (PHS), Orthogonal Frequency Division Multiple Access (OFDMA).

23. The telephone system according to claim 15 wherein the radio communications means communicates according to a radio communications format selected from the group consisting of: analog 46/49 MHz FM modulation; digital spread spectrum 900 MHz; digital spread spectrum 2.4 GHz; digital spread spectrum 5.8 GHz; 802.11 and BLUETOOTH.

24. The telephone system according to claim 15 wherein the one or more handsets includes:
a means for automatically completing telephone numbers being entered by a user such that the user does not have to enter all of the digits comprising the telephone number.

25. The telephone system according to claim 24 wherein the one or more handsets includes:
a means for learning the telephone numbers which are to be automatically completed.

26. The telephone system according to claim 25 wherein the one or more handsets includes:
a means for remembering the telephone numbers which are to be automatically completed.

27. The telephone system according to claim 26 wherein the one or more handsets includes:
a means for presenting to a user the remembered telephone numbers which are to be automatically completed, such that they are presented in most-often-called order.

28. The telephone system according to claim 27 wherein the one or more handsets includes:
a means for selecting the ordered telephone numbers for subsequent dialing.

29. The telephone system according to claim 17 further comprising:
a means for providing full-duplex cellular communications.

30. The telephone system according to claim 29 further comprising:
a means for providing full-duplex radio communications.

31. The telephone system according to claim 30 wherein the means for providing full-duplex cellular communications and the means for providing full-duplex cordless communications operate simultaneously.

32. A method of making a telephone call comprising the steps of:
establishing, a radio communications link between a radio handset and a base unit, the base unit including:
a cellular communications sub-system;
a radio communication sub-system; and
instructing, via the radio communications link, the base unit to initiate a cellular telephone call.

33. The method of claim 32 further comprising the steps of:
providing, via the radio communications link, a dial tone indicative of cellular service availability to a user of the radio handset.

34. The method of claim 32 further comprising the steps of:
establishing, a cellular telephone call between the base unit and a cellular service provider.

35. The method of claim 34 further comprising the steps of:
conducting, the established cellular telephone call.

36. The method of claim 35 wherein the radio communications link utilizes a radio communications format selected from the group consisting of: analog 46/49 Mhz FM modulation; digital spread spectrum 900 MHz; digital spread spectrum 2.4 GHz; digital spread spectrum 5.8 GHz; 802.11 and BLUETOOTH.

37. The method of claim 32 wherein the cellular communications sub-system communicates according to a cellular communications format selected from the group consisting of: Code Division Multiple Access (CDMA), Wideband Code Division Multiple Access (WCDMA Wideband CDMA), Groupe Special Mobile (GSM), Time Division Multiple Access (TDMA), Advanced Mobile Phone System (AMPS), Personal Digital Cellular (PDC), Personal Handy-Phone System (PHS), Orthogonal Frequency Division Multiple Access (OFDMA).

38. The method of claim 32 wherein the radio communications link is a full-duplex communications link.

39. A cellular telephone comprising:
control circuitry;
a cellular transceiver, connected to the control circuitry for transmitting and receiving cellular telephone signals to/from a cellular base station;
a radio transceiver, connected to the control circuitry for transmitting and receiving radio telephone signals to/from a radio base unit; and
selection circuitry for selecting which transceiver, cellular or radio is used for telephonic communication.

40. The telephone according to claim 39 further comprising:
a signal evaluator, connected to the selection circuitry, for evaluating the radio telephone signals received from the radio base unit;
such that if the radio telephone signals received from the radio base unit fall below a pre-defined threshold, the selection circuitry automatically selects cellular operation.

41. The telephone according to claim 39 further comprising:
a microphone connected to the control circuitry for providing voice signals to the control circuitry;
a speaker connected to the control circuitry for receiving voice signals from the control circuitry.

42. The telephone according to claim 39 further comprising:
a manually-operated switch connected to the selection circuitry;
such that when the manually-operated switch is in a “cellular” position the telephone only operates in a cellular manner and when the manually-operated switch is in a “radio” position the telephone only operates in a radio manner.

43. The telephone according to claim 39 further comprising:
a keypad, connected to the control circuitry, for permitting a user to input a telephone number.

44. The telephone according to claim 39 further comprising:
dial tone generating circuitry, connected to the control circuitry, for providing an audible indication that cellular service is available.

45. The telephone according to claim 43 further comprising:
telephone number generating circuitry, connected to the control circuitry, for automatically completing the input of a telephone number without requiring the user to input the entire number.

46. The telephone according to claim 43 further comprising:
area code number generating circuitry, connected to the control circuitry, for automatically generating an area code number of a dialed telephone number, without requiring the user to input the entire area code number.

47. The telephone according to claim 46 wherein the area code generating number circuitry automatically generates an area code number of a dialed number without requiring the user to input the entire area code number when the area code of the dialed number is the same as the area code of a telephone number associated with the telephone.

48. The telephone according to claim 46 wherein the area code generating number circuitry automatically generates an area code number of a dialed number without requiring the user to input the entire area code number when the area code of the dialed number is the same as the area code of a telephone number previously called and stored in the telephone memory.

49. The telephone according to claim 41 wherein the cellular transceiver communicates according to a cellular communications format selected from the group consisting of: Code Division Multiple Access (CDMA), Wideband Code Division Multiple Access (WCDMA Wideband CDMA), Groupe Special Mobile (GSM), Time Division Multiple Access (TDMA), Advanced Mobile Phone System (AMPS), Personal Digital Cellular (PDC), Personal Handy-Phone System (PHS), Orthogonal Frequency Division Multiple Access (OFDMA).

50. The telephone according to claim 41 wherein the radio transceiver communicates according to a radio communications format selected from the group consisting of: analog 46/49 MHz FM modulation; digital spread spectrum 900 MHz; digital spread spectrum 2.4 GHz; digital spread spectrum 5.8 GHz; 8002.11 and BLUETOOTH.

51. The telephone according to claim 41 further comprising a telephone number assignment circuit, connected to the control circuit, for dynamically assigning a cellular telephone number to the telephone wherein the cellular telephone number is shared among one or more other telephones.

52. A telephone system comprising:
a telephone unit including:
a means for providing telephonic communications via a telephone service provider;
a means for providing radio communications to one or more remote alerting devices; and
the one or more remote alerting devices including:
a means for providing radio communications between the remote alerting device and the base unit; and
a means for notifying a user of an incoming call;
such that when an incoming call is received by the telephone unit, it signals the remote alerting device(s) via the radio communications means to notify the user who is thereafter notified.

53. The telephone system according to claim 52 wherein the user notifying means is an audible notifying means.

54. The telephone system according to claim 53 wherein the user notifying means is a visual notifying means.

55. The telephone system according to claim 52 wherein the user notifying means is a mechanical notifying means.

56. A telephone system comprising:
a telephone unit including:
a means for providing telephonic communications via a telephone service provider;
a means for providing radio communications to one or more remote devices;
a means for determining a predetermined event which results from monitoring the radio communications means; and
a means for notifying a user of the predetermined event
the one or more remote devices including:
a means for providing radio communications between the remote alerting device and the base unit;
such that when the predetermined event is determined by the telephone unit, it notifies the user of the event.

57. The telephone system according to claim 57 wherein the predetermined event is indicated when one of the remote devices exceeds a certain distance from the telephone unit.

58. The telephone system according to claim 57 wherein the predetermined event is indicated when the radio communications link signal strength between one of the remote devices and the telephone unit falls below a threshold.

59. The telephone system according to claim 56 wherein the user notifying means is an audible notifying means.

60. The telephone system according to claim 56 wherein the user notifying means is a visual notifying means.

61. The telephone system according to claim 56 wherein the user notifying means is a mechanical notifying means.

62. A cellular telephone comprising:
control circuitry;
a cellular transceiver, connected to the control circuitry for transmitting and receiving cellular telephone signals to/from a cellular base station;
a microphone connected to the control circuitry for providing voice signals to the control circuitry;
a speaker connected to the control circuitry for receiving audio signals from the control circuitry;
a keypad, connected to the control circuitry for permitting a user to input a telephone number; and
a number collector/evaluator, for collecting successive numbers entered by the user via the keypad, and evaluating the number(s) when entered by the user such that the cellular phone automatically transmits the evaluated number—when a pre-determined criteria is met—to a cellular telephone network without requiring the user to explicitly initiate the transmission.

63. The telephone system according to claim 62 wherein the pre-determined criteria is met when the user enters a complete telephone number.

64. The telephone system according to claim 62 wherein the pre-determined criteria is met when a pre-determined period of time elapses.

65. The telephone system according to claim 62 further comprising a dial tone generator, which provides an audio indication to the user of cellular service availability.

66. The telephone system according to claim 62 further comprising an error generator, which provides an audio indication to the user of an error condition associated with the number being entered/evaluated.

67. In a telephone system comprising:
a base unit including:
a cellular communications sub-system for providing cellular communications via a cellular service provider;
a radio communications sub-system for providing radio communications to one or more handsets; and
a base unit cellular sub-system disabler;
a handset including:
a radio communications sub-system for providing radio communications between the one or more handsets and the base unit; and
a cellular communications sub-system for providing cellular communications via a cellular service provider; and
a handset cellular number disabler;
wherein the base unit has associated with it a particular cellular telephone number and the handset has associated with it the same cellular telephone number;
wherein if the handset determines that it is within satisfactory radio communications range of the base unit, it disables its cellular sub-system; and
wherein if the base unit determines that the handset is not within satisfactory radio communications range of the base unit, it disables its cellular sub-system;
such that if the handset is within satisfactory radio communications range of the base unit, and the telephone number associated with the base unit is dialed, the base unit receives the call and may optionally ring through the handset via the radio communications sub-system, and if the handset is not within satisfactory radio communications range of the base unit, the base unit disables its cellular sub-system so that when the telephone number associated with the base unit is dialed, only the handset receives the call.

68. A method of operating a telephone system, the telephone system comprising:
a base unit including:
a cellular communications sub-system for providing cellular communications via a cellular service provider;
a radio communications sub-system for providing radio communications to one or more handsets;
a call forwarding system;
wherein the base unit has associated with it a unique cellular telephone number;
one or more handsets including:
a radio communications sub-system for providing radio communications between the one or more handsets and the base unit; and
a cellular communications sub-system for providing cellular communications via a cellular service provider;
wherein each of the handsets have associated with it a unique cellular telephone number;
the method of operating the telephone system comprising the steps of:
determining, according to a pre-determined criteria, whether to forward calls directed to the base station to one of the handsets; and
automatically forwarding, when the pre-determined criteria is met, calls directed to the base station to one of the handsets.

69. The method according to claim 68 further comprising the steps of: polling, of the handsets by the base system to determine whether the pre-determined criteria is met.

70. A method of operating a telephone system, the telephone system comprising:
a base unit including:
a cellular communications sub-system for providing cellular communications via a cellular service provider;
a radio communications sub-system for providing radio communications to one or more handsets;
wherein the base unit has associated with it a unique cellular telephone number;
one or more handsets including:
a radio communications sub-system for providing radio communications between the one or more handsets and the base unit; and
a cellular communications sub-system for providing cellular communications via a cellular service provider;
wherein each of the handsets have associated with it a unique cellular telephone number;
the method of operating the telephone system comprising the steps of:
receiving, at the base set an incoming telephone call directed to its unique cellular telephone number; and
notifying each of the handsets, according to a pre-determined criteria, of the presence of the incoming call such that users of the handset(s) may accept the call.

71. The method according to claim 70 further comprising the steps of: conducting, the accepted cellular telephone over the radio link between the handset accepting the call and the base set.
